(19) United States
(12) Patent Application Publication
(10) Pub. No.: US 2026/0075449 A1
(43) Pub. Date: Mar. 12, 2026

(54) METHODS, ARCHITECTURES, APPARATUSES AND SYSTEMS FOR NEAR-FIELD AND/OR FAR-FIELD BEAM SELECTION

(71) Applicant: InterDigital Patent Holdings, Inc., Wilmington, DE (US)

(72) Inventors: Yifan Li, Conshohocken, PA (US); Afshin Haghighat, Ile-Bizard (CA); Patrick Svedman, Stockholm (SE); Allan Yingming Tsai, Boonton, NJ (US); Salah Elhoushy, LaSalle (CA); Chia-Hung Wei, Chesterbrook, PA (US); Benoit Pelletier, Roxboro (CA); Ravikumar Pragada, Warrington, PA (US)

(21) Appl. No.: 18/827,969

(22) Filed: Sep. 9, 2024

(51) Int. Cl. H04W 24/10; H04L 5/00; H04W 52/08; H04W 72/23

(52) U.S. Cl. CPC H04W 24/10; H04L 5/0048; H04W 52/08; H04W 72/23

(57) ABSTRACT

Procedures, methods, architectures, apparatuses, systems, devices, and computer program products for beam selection. A wireless transmit/receive unit, WTRU, measures received power of a received first downlink, DL, reference signal, RS, received from a network, and, upon determination that a value based on the measured received power satisfies at least one first criterion, determines a value range to which the value belongs, determines a set of second DL RS associated with the determined value range, measures the determined set of second DL RS to obtain a corresponding set of first measurement results, selects a DL RS from the set of second DL RS based on the set of first measurement results, and transmits, to the network, information indicative of at least one of the selected DL RS and the corresponding first measurement result.

### BACKGROUND

The present disclosure is generally directed to the fields of communications, software and encoding, including, for example, to methods, architectures, apparatuses, systems directed to near-field (NF) and/or far-field (FF) beam selection.

### SUMMARY

In a first aspect, the present principles are directed to a method at a wireless transmit/receive unit, WTRU, comprising measuring received power of a received first downlink, DL, reference signal, RS, received from a network, upon determination that a value based on the measured received power satisfies at least one first criterion: determining a value range to which the value belongs, determining a set of second DL RS associated with the determined value range, measuring the determined set of second DL RS to obtain a corresponding set of first measurement results, selecting a DL RS from the set of second DL RS based on the set of first measurement results, and transmitting, to the network, information indicative of at least one of the selected DL RS and the corresponding first measurement result.

In a second aspect, the present principles are directed to a wireless transmit/receive unit, WTRU, comprising at least one processor configured to measure received power of a received first downlink, DL, reference signal, RS, received from a network, upon determination that a value based on the measured received power satisfies at least one first criterion: determine a value range to which the value belongs, determine a set of second DL RS associated with the determined value range, measure the determined set of second DL RS to obtain a corresponding set of first measurement results, select a DL RS from the set of second DL RS based on the set of first measurement results, and transmit, to the network, information indicative of at least one of the selected DL RS and the corresponding first measurement result.

In a third aspect, the present principles are directed to a wireless transmit/receive unit, WTRU, comprising at least one processor configured to measure received powers of a first set of received downlink, DL, reference signals, RS, select a first DL RS from the first set based on the measured received powers, determine a second set of DL RS that is associated with the first DL RS, measure the determined second set of DL RS to obtain respective measurement results, determine a RS based on the measurement results, and transmit information indicative at least one of the determined RS and the respective measurement results.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIGS. 2A-2C respectively illustrate three procedures/phases of NR DL beam management;

FIG. 3 illustrates example NF beams and an example FF beam;

FIG. 4 illustrates an example of a configuration selection function according to an embodiment of the present principles;

FIG. 5 illustrates an example of disjoint subsets according to an embodiment of the present principles;

FIG. 6 illustrates an example of overlapping subsets according to an embodiment of the present principles;

FIG. 7 illustrates an example of overlapping subsets and index wraparound according to an embodiment of the present principles;

FIGS. 8A-8C illustrate examples of CSI-RS assigned to 2D grid points according to embodiments of the present principles;

FIGS. 9A-9C illustrate examples of CSI-RS assigned to 3D grid points according to embodiments of the present principles;

FIG. 10 illustrates an example 2D grid with disjoint CSI-RS subsets according to an embodiment of the present principles;

FIG. 11 illustrates an example illustration of overlapping subsets based on a 2D grid according to an embodiment of the present principles;

FIG. 12 illustrates an example flowchart of a method of distance-based RS determination and CSI reporting determination for NF beam selection according to an embodiment;

FIG. 13 illustrates an example flowchart of a method for non-distance-based RS determination for NF beam selection with 1-stage reporting according to an embodiment;

FIG. 14 illustrates an example of association between pathloss range and RS set according to an embodiment;

FIG. 15 illustrates an example flowchart of a method for distance-based RS determination for NF beam selection with 1-stage reporting according to an embodiment;

FIG. 16 illustrates an example flowchart of distance-based RS determination for NF beam selection with 2-stage reporting according to an embodiment;

FIG. 17 illustrates an example flowchart of a method for distance-based CSI reporting determination and RS set determination for NF beam selection with 2-stage reporting according to an embodiment;

FIG. 18 illustrates an example of association between RS and a combination of pathloss range and direction according to an embodiment.

FIG. 19 illustrates an example flowchart of a method for distance and direction-based RS determination and CSI reporting determination for NF beam selection with 1-stage reporting according to an embodiment;

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

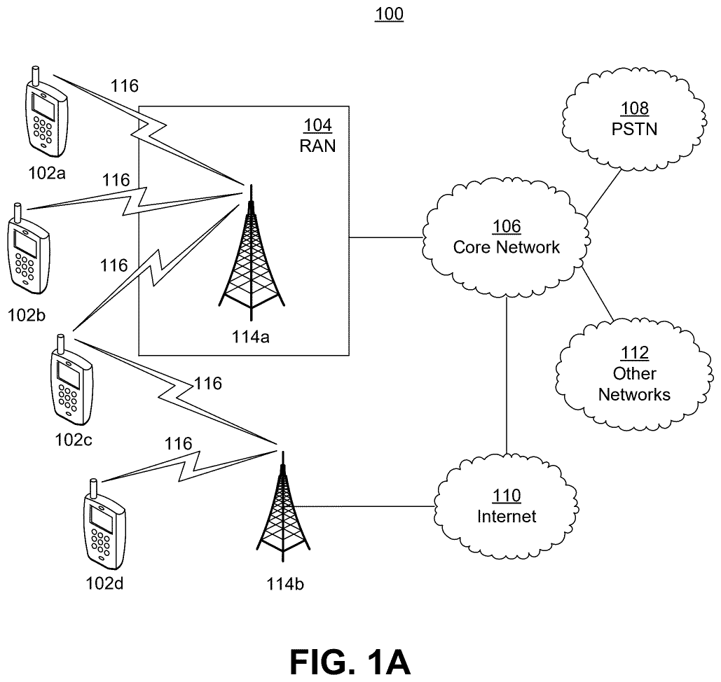

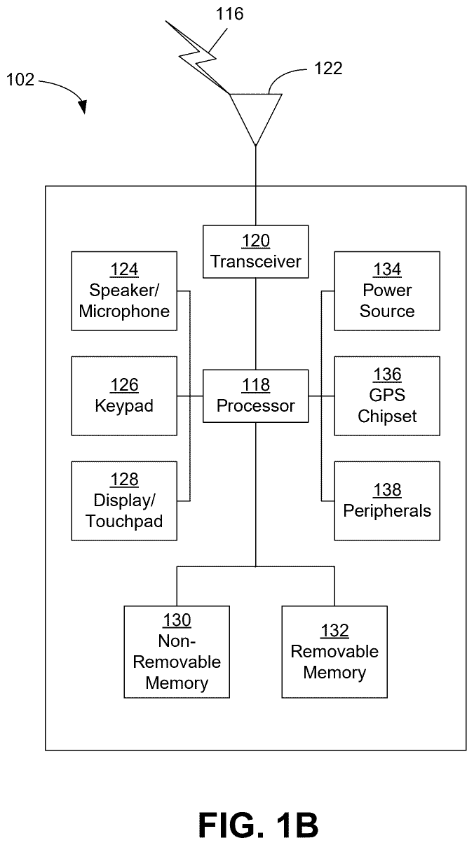

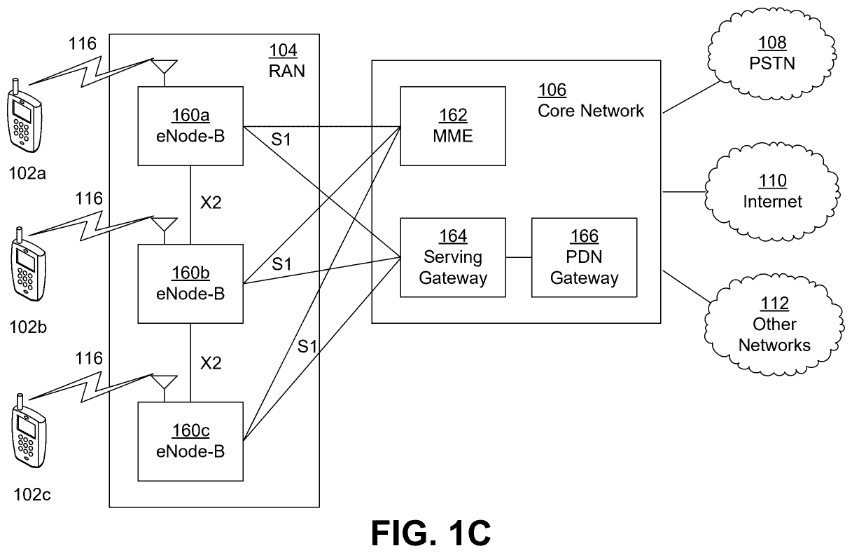

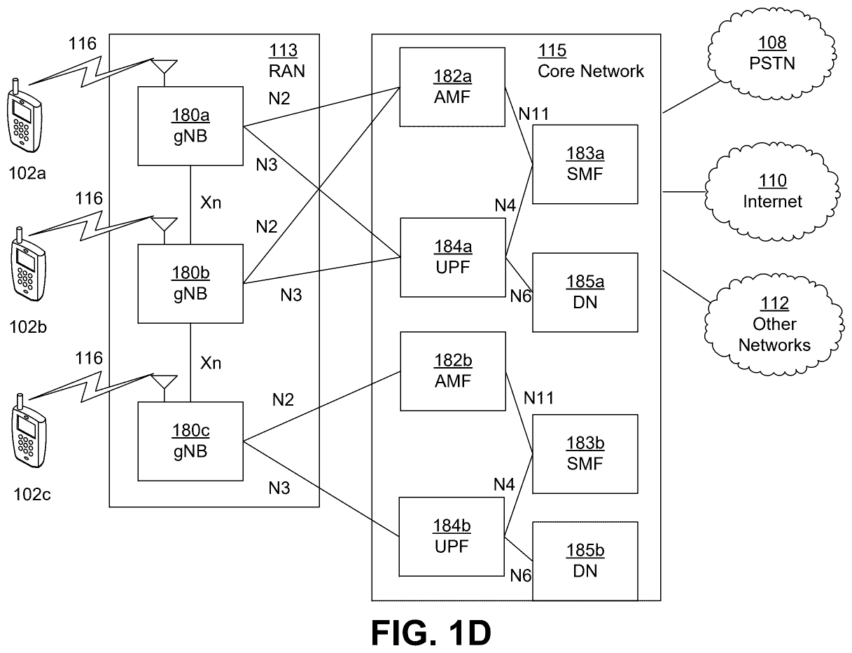

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

State-of-the-art wireless communications systems are typically designed based on the assumption that transmission/reception happens in the so-called “far field”, which means that radio wave propagation can be accurately modeled as a planar wave. However, with increasingly large Transmission Reception Point (TRP) arrays in relation to the wavelength, and with denser TRP deployments, the likelihood of UEs being in the so-called “near field” increases. In the near field, the planar wave approximation is no longer accurate and spherical wave propagation needs to be considered.

Near-field (NF) spot beam focusing is a beamforming scheme where beamforming weights are associated with distance information. Using spot beam focusing, a NF beam can focus a desired signal for a specific UE at the intended location without generating much interference to other UEs situated elsewhere. Unlike far-field (FF) beams, NF spot beam focusing can steer a beam not only in a specific spatial direction but also to a specific location (i.e. a specific spatial direction and a specific distance). As a result, to form a NF beam, both distance and angular information are required for determining the beamforming weights, while only angular information is required to form for the beamforming weights for an FF beam.

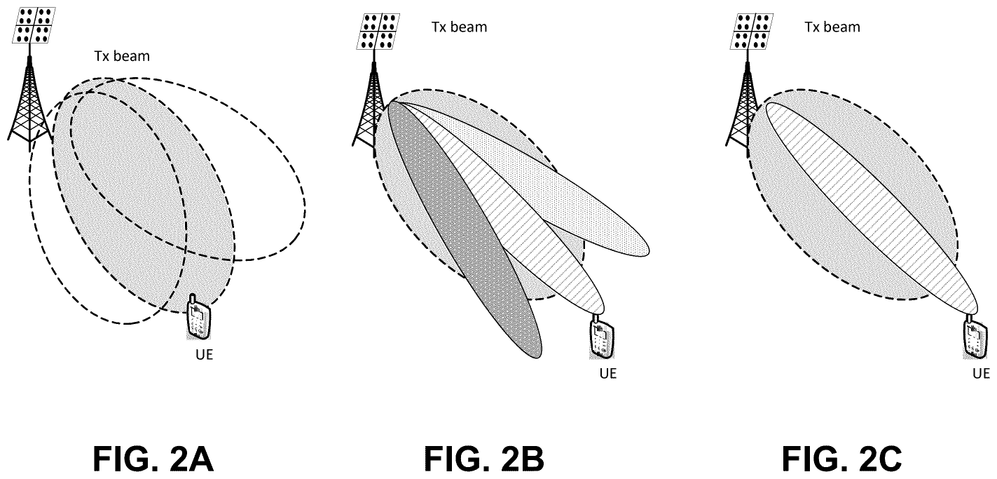

In NR, existing beam management only considers far-field beams and assumes a planar wave (MIMO) channel model, i.e., spatial information only relies on angular information. The NR DL beam management procedure typically involves three procedures/phases, i.e., P1, P2 and P3, respectively illustrated in FIGS. 2A, 2B and 2C.

The main purpose of P1 is for the gNB to determine a coarse DL Tx beam (i.e., gNB DL Tx wide beam). The gNB can for example sweep a SSB beam, and the UE sweep a DL Rx beam to select a best DL Tx beam (e.g., the best SSB beam measured by the UE) and report it to the gNB.

P2 is mainly for beam refinement for the transmitter (i.e., gNB DL Tx narrow beam). The gNB can refine its beam (e.g., by sweeping a narrower beam over a narrower range) and the UE detects the best one and reports it to gNB, for example as in P1.

Finally, P3 is mainly for beam refinement for the receiver (i.e., UE DL Rx beam), in which the UE sweeps its Rx beam and determines the receiving beam to use.

The present principles mainly consider a network that provides both near field beams and far field beams to serve the UEs in a region. However, the present principles may also be applicable to only near field beams, or only far field beams.

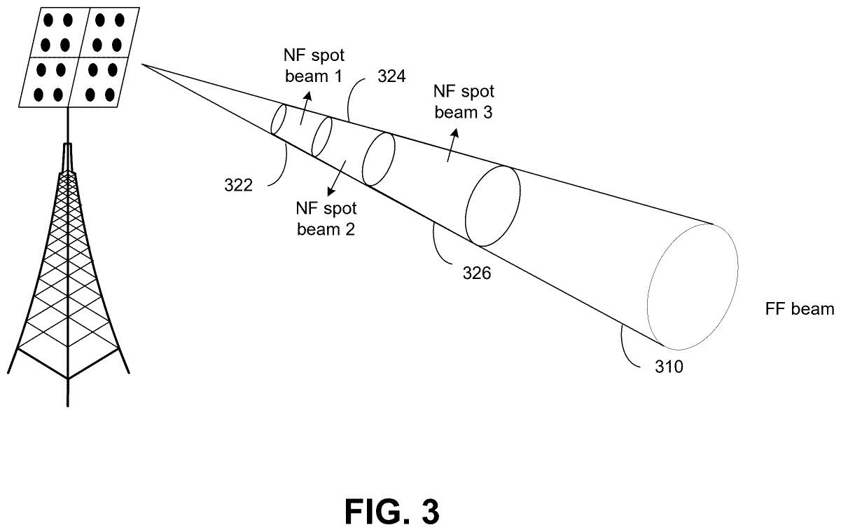

In legacy FF beam sweeping, the beams only need to sweep in different directions. Due to the property of the near field beam (also called “spot beam”), the NF beam “sweeping” should consider different directions and different distances. FIG. 3 illustrates example NF beams and an example FF beam. The FF beam 310 can serve all the UEs at different distances within a cone region (characterized by the angle/direction of the beam) and the same beamforming gain is maintained with increasing distance. However, a NF beam serves the UE located around the focus distance within the cone region. The coverage region is a 3D region/volume characterized by the angle/direction and the focus distance. As shown, the NF spot beams 322, 324, 326 lie within a cone, with NF spot beam 1 322 closer to the transmission point 330 than NF spot beam 2 324, which in turn is closer than NF spot beam 3 326. It will be appreciated that the number of candidate spot beams may be very big.

NR currently supports explicit configuration, triggering, activation, etc., of (candidate) Channel-State Information Reference Signals (CSI-RS) resource sets and corresponding reporting for FF beam management. However, reusing this CSI framework for NF beam management may lead to high system overhead. As a first example, in case the network configures all the candidate spot beams to the UE and the UE needs to measure them, this can lead to high measurement overhead and high power consumption. As a second example, in case the network explicitly configures all candidate subsets of spot beams to the UE and triggers one subset for the UE to measure, this can lead to high configuration overhead and high triggering overhead. As a third example, in case the network configures a portion of all the candidate subsets to the UE and triggers one subset for the UE to measure, this can lead to high reconfiguration overhead.

It will be understood that it is desired to have a solution that can reduce at least one of the configuration, triggering, activation, measuring and reporting overhead of CSI-RS for NF BM by taking near field spot beam properties into account.

According to the present principles, NF beam management is enabled by associating RS configuration and reporting with distance. For example, UE can be configured with multiple reference signals representing near-field beams (associated with different distances) and far-field beams. The UE can be configured with multiple CSI reporting configurations (associated with different distances) for near-field. The UE can estimate its pathloss and select a subset of RS to measure for beam selection based on the estimated pathloss, select a CSI reporting based on the estimated pathloss to report the measurement result.

In one example embodiment, which will later be described in further detail, a UE can perform at least some of the steps of the following method.

The UE is configured with at least one of one or more of a first DL RS and corresponding DL RS transmit power for pathloss estimation, multiple pathloss ranges, one or more of a second DL RS for far-field beam selection, one or more of a third DL RS for near-field beam selection (where each third RS is associated with one or more configured pathloss ranges), and multiple CSI reporting configurations (where each CSI reporting configuration is associated with a configured pathloss range).

The UE performs an initial pathloss estimation using the first configured DL RS and determines the pathloss. The UE may report the determined pathloss to the gNB or not, depending on variant.

In case the determined pathloss is above a configured threshold value, the UE performs a second measurement using the second configured RS signal to determine a far-field beam.

In case the determined pathloss is below the configured threshold, the UE determines the pathloss range corresponding to the determined pathloss. The UE determines the CSI reporting configuration that is associated with the determined pathloss range.

The UE determines a subset of the configured third DL RS that is associated with the determined pathloss range and measures the determined subset of third DL RS to determine a near-field beam.

The UE reports the measurement result using the determined CSI reporting configuration.

It will be appreciated that the present principles, it can help reduce the system overhead, e.g., configuration overhead at the gNB side, measurement overhead at the UE side, etc., in near-field beam management (BM) compared to a legacy NR solution already described.

Before any further description, some terminology will be explained.

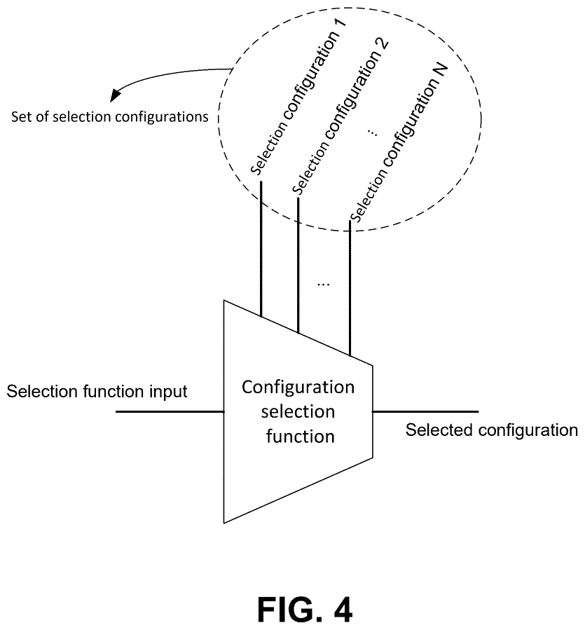

A configuration selection function is a function by which the UE selects the selected configuration from a set of selection configurations based on input to the selection function input. FIG. 4 illustrates an example of a configuration selection function according to an embodiment of the present principles.

Selection function input is information based on which the UE selects the selected configuration from the set of selection configurations. The selection function input can be for example one or more of explicit distance information, implicit distance information, non-distance information, RS index, etc.

Explicit distance information may for example be focus distance information, which may correspond to a distance between a TRP and the UE. Implicit distance information may for example be RS received power (RSRP), signal to interference and noise power ratio (SINR), pathloss, zone ID, phase shift(s) between antenna ports of a multi-port CSI-RS, etc. Non-distance information may for example be angular information, measurement of multiple reference signal, e.g., multiple CSI-RS, etc.

A set of input values (also called an input value set) is one or more values of the selection function input that is associated with a selection configuration. Different sets of input values may be associated with different selection configurations. For example, the UE determines the selection configuration to select based on the set of input values to which the measured selection function input belongs. A set of input values may for example represent a value, one or more threshold values, a set of values, a value range of the selection function input.

A selection configuration is a candidate configuration for the UE to select through the selection function. A selection configuration can be a RS or a RS set, e.g., for NF beam selection, a CSI reporting configuration, e.g., for NF beam selection, a beam management option, e.g., NF beam selection or FF beam selection, etc.

A set of selection configurations is the set from which the selection function selects the selected configuration based on the selection function input. The set of selection configurations can for example be a set of RS or a set of RS sets, e.g., for NF beam selection, a set of CSI reporting configurations, e.g., for NF beam selection, a set of beam management options such as NF beam selection and FF beam selection, etc.

A selected configuration is at least one selection configuration selected by the UE from the set of selection configurations using the configuration selection function. For example, using the configuration selection function, the UE may select one or more RS or RS set to measure for determining the preferred NF beam. Or the UE may select the CSI reporting configuration for reporting the selected beam to the gNB.

Aspects of the present principles briefly described hereinabove will now be described in detail.

### UE Configuration

A UE may receive, e.g., from a network, information relating to one or more configuration(s) and/or reconfiguration(s), e.g., with radio resource control (RRC) signaling, in one or more RRC message(s).

### RS or RS Set Configuration

The UE may be configured with a RS or a RS set as a selection configuration, e.g., for determining the RS(s) to be measured for NF beam selection. The UE may be configured with multiple RS or RS sets to form the set of selection configurations. The RS(s) may be CSI-RS, DMRS, SSB, etc., or a combination thereof. Herein, CSI-RS is used as a non-limitative example, but it will be understood that other kinds of RS may also be used instead or in addition to the CSI-RS.

Configured CSI-RS. The UE may receive information relating to one or more configurations of a configured CSI-RS, e.g., for NF beam selection. A configured CSI-RS may be configured with one or more CSI-RS Ids, for example a CSI-RS resource Id. A configured CSI-RS may be configured with a plurality of CSI-RS Ids, for example a first, e.g., mandatory, CSI-RS Id that may be used for explicit network-configured inclusion of the CSI-RS in a configured set of CSI-RS, e.g., a CSI-RS resource Id, and a second, e.g., optional, CSI-RS Id that may be used by the UE, for example, to determine CSI-RS subsets.

Configured set of CSI-RS. The UE may receive information relating to one or more configurations of a configured set of one or more CSI-RS, e.g., for NF beam selection. A configuration of a configured set of CSI-RS may for instance include a set of CSI-RS Ids, identifying the CSI-RS included in the set.

Explicitly configured CSI-RS subsets. The UE may receive information relating to a configuration of one or more CSI-RS subsets, wherein a CSI-RS subset may include one or more CSI-RS from the configured set of CSI-RS.

In one example, a CSI-RS may be configured with a parameter that indicates the inclusion of the CSI-RS in a CSI-RS subset. For instance, the parameter may include a CSI-RS subset Id corresponding to the CSI-RS subset in which the CSI-RS is included. A parameter value, e.g., 0, may correspond to inclusion in no CSI-RS subset. Alternatively, absence of the parameter in the CSI-RS configuration may correspond to inclusion in no CSI-RS subset. In an example, e.g., in which a CSI-RS may be included in multiple CSI-RS subsets, the parameter may include a list of CSI-RS subset Ids corresponding to the subsets in which the CSI-RS is included.

In another example, the UE may be configured with a list of CSI-RS subset(s), e.g., including CSI-RS resource set(s). A CSI-RS subset configuration may include a list of CSI-RS, e.g., in the form of CSI-RS Id(s), corresponding to the CSI-RS included in the CSI-RS subset.

Implicitly configured CSI-RS subsets. The UE may be configured and/or pre-configured with one or more parameters, based on which the UE may determine the CSI-RS subsets. This may be referred to as implicitly configured CSI-RS subsets. Examples of such parameters are described in more detail hereinafter (see e.g., section “UE determination of RS or RS set for NF beam selection”).

Single- or multi-port CSI-RS Resources. The configured CSI-RS may correspond to a single-port CSI-RS resource, a dual-port CSI-RS resource, or a multi-port CSI-RS resource. The configured set of CSI-RS may correspond to a set of single-port CSI-RS resource(s), a set of dual-port CSI-RS resource(s), or a set of multi-port CSI-RS resource(s). The configured set of CSI-RS may correspond to CSI-RS resource(s) in one or more CSI-RS resource sets, e.g., non-zero-power CSI-RS resource sets. The configured set of CSI-RS may correspond to a set of antenna ports, e.g., of one or more CSI-RS resource(s).

CSI-RS time-domain behavior. The CSI-RS may be configured to be periodic, e.g., the UE may receive the CSI-RS with a configured periodicity and time offset to a time reference. A time reference may for instance be a slot or frame timing of a serving cell, e.g., the serving cell in which the CSI-RS are configured or received.

The CSI-RS may be configured to be semi-persistent, e.g., when the CSI-RS is activated, the UE may receive the CSI-RS with a configured periodicity and time offset to a time reference. The UE may receive a CSI-RS activation and/or deactivation indication for a semi-persistent CSI-RS in a medium access control (MAC) control element (CE) or in a downlink control information (DCI). A MAC CE may be carried in a PDSCH. A DCI may be carried in a PDCCH.

The CSI-RS may be configured to be aperiodic, e.g., the UE may receive one or more occasions of an aperiodic CSI-RS after the reception of a DCI that triggers the CSI-RS. The UE may receive the CSI-RS a time offset after receiving the PDCCH that carried the DCI that triggered the CSI-RS, for example a configured time offset, or a time offset indicated by the DCI, or a combination thereof.

CSI-RS with/without repetition. A CSI-RS may be configured with or without repetition enabled.

For a CSI-RS with repetition enabled, the UE may receive multiple occasions of the CSI-RS, e.g., in consecutive symbols or slots. The UE may assume that the multiple occasions were transmitted on the same effective channel, e.g., with the same Tx beam. The UE may use the multiple occasions for adjusting its Rx beam.

For a CSI-RS with repetition disabled, the UE may receive multiple occasions of the CSI-RS, e.g., separated by the CSI-RS periodicity. The UE may use the multiple occasions for adjusting its Rx beam, even though the UE might not assume that the occasions were transmitted on the same effective channel, e.g., with the same Tx beam.

### Configuration of Selection Function Input

Configured selection function input. The UE may be configured with one or more selection function inputs. The UE may use the configured selection function input for determining a selected configuration, e.g., whether to perform FF beam selection or NF beam selection. The UE may use the configured selection function input for determining the RS or RS set, e.g., for NF beam selection. The UE may use the configured selection function input for determining the CSI reporting, e.g., to report the selected NF beam(s) or preferred NF beam(s). It is noted that the configuration, instead of including the input value(s)/range(s) used in the selection function, may include the metric(s), RS(s) measurement(s), etc., to use as input(s).

Configured selection function input for determining NF beam selection or FF beam selection. The UE may be configured with one or more sets of input values of the selection function input for the UE to determine the selected beam selection configuration, e.g., whether to perform FF beam selection or NF beam selection. The set of input values may be one or more threshold(s), value(s), value range(s), etc.

### Configured Selection Function Input for Determining the RS or RS Set for NF Beam Selection

The UE may be configured with the set of input values of the selection function input for the UE to determine the RS or the RS set for NF beam selection. The set of input values may be a threshold value, a value, or a value range, etc.

The selection function input for determining the RS or RS set for NF beam selection may for example be one or more CSI-RS. The set of input values of the determination may be obtained through comparison between one or more measured CSI-RS. For example, the UE compares a single measured CSI-RS with a threshold value. For example, the UE compares the measurement results resulting from multiple CSI-RS to determine the RS or RS set for NF beam selection. This CSI-RS may be transmitted in a less frequent manner to reduce the measurement overhead on the UE side. For example, the periodicity of this CSI-RS can be longer than the periodicity of the RS or RS set for beam selection. Therefore, the UE can first measure the less frequent CSI-RS to determine one or more RS or RS set and then measure the more frequent RS or RS set for beam selection.

### Configured Selection Function Input for Determining the CSI Reporting

The UE may be configured with the set of input values of the selection function input for the UE to determine the CSI reporting to be used for reporting the selected NF beam(s) or preferred NF beam(s). The set of input values may be a threshold value, a value, or a value range, etc.

The selection function input for determining the CSI reporting may for example be a CSI-RS or a CSI-RS Id. The set of input values of the determination may be obtained through comparison between the measured CSI-RS in which the UE compares the measurement results among multiple CSI-RS to determine the CSI reporting to be used.

### CSI Reporting Configuration

A UE may be configured with a CSI reporting configuration as a selection configuration for determining the resource used to report the selected configuration or to report the determined NF beam(s). The UE may be configured with multiple CSI reporting configurations which form the set of selection configurations.

CSI reporting setting. The UE may be configured with one or more CSI reporting setting. A CSI reporting setting may be configured with a CSI reporting setting identity/identifier (Id). A selection configuration may include a CSI reporting setting. A CSI reporting setting may for instance include a CSI reporting configuration including one or more of reporting quantity/quantities (also called metric(s)), number of reported CSI-RS, time domain properties such as periodic, semi-persistent, aperiodic, and corresponding periodicities, time offsets, etc., and other configurations described herein.

Reporting quantities. A reporting quantity may for example be RS received power (RSRP), signal to interference and noise power ratio (SINR), channel quality indicator (CQI), precoding matrix indicator (PMI), rank indicator (RI), focus distance, pathloss, zone ID, phase difference, CSI-RS index, or angular information.

Reporting threshold. The UE may be configured with one or more threshold values. The UE may be configured to use a threshold to determine the selected configuration or NF beam to report, for instance by reporting selected configuration or NF beam with a quantity above or below a threshold value.

Periodic CSI reporting. The UE may be configured to transmit a CSI report periodically, e.g., on a PUCCH. The UE may be configured with multiple CSI reporting settings with periodic reporting that may correspond to the same or different reporting quantities, RS(s), periodicities, PUCCH resources, etc.

Semi-persistent CSI reporting. The UE may be configured to transmit a CSI report semi-persistently, e.g., on a PUCCH or PUSCH, with a configured periodicity and/or time offset, when reporting is activated. The UE may be configured with multiple CSI reporting settings with semi-persistent reporting on PUCCH and/or PUSCH that may correspond to the same or different reporting quantities, RS(s), periodicities, PUCCH resources, etc.

Aperiodic CSI reporting. The UE may be configured to transmit a CSI report aperiodically on PUSCH when reporting is triggered. The UE may be configured with one or more CSI trigger states that each may correspond to one or more CSI reporting setting(s).

### Configuration of Mapping Between RS/RS Set and Selection Function Input

As will be seen, there may be an association between RS/RS set for NF beam selection and selection function input.

The UE may receive configuration information that associates one or more RS or RS set for NF beam selection with one or more selection function inputs. The UE may determine the measurement result of the configured selection function input and determine the RS or RS set that is associated with the measured result for NF beam selection.

For example, one RS or RS set is associated with one or more selection function inputs and corresponding set of input values. Multiple RS or RS sets may be associated with the same selection function input and same set of input values. One RS or RS set may be associated with the multiple different selection function inputs and/or sets of input values.

In one example, an RS or RS set may be associated with one or more distance values or one or more distance ranges. A distance range may be configured through the value of the lower bound of the distance range and the value of the upper bound of the distance range. In another example, the distance range may be configured through the value of the lower bound of the distance range and the value of the difference between the lower bound and the upper bound. Or the distance range may be configured through the value of the upper bound of the distance range and the value of the difference between the lower bound and the upper bound. One or more distance ranges may be configured to be associated with multiple RS or RS sets respectively. These distance ranges may be uniformly distributed, i.e., the difference between the lower bound and the upper bound for different distance ranges are the same. In this case, a step size or a value of the difference may be configured to be applied to all the distance ranges. The distance ranges may also be non-uniformly distributed, i.e., the difference between the lower bound and the upper bound for different distance ranges are the different. In this case, separate step size or separate value of the difference may be configured for the distance ranges respectively.

The notion in the previous paragraph may be also applied to other selection function input metrics. For example, instead of ‘distance,’ the notion in the previous paragraph also works with ‘RSRP’, ‘SINR’, ‘pathloss’, ‘zone ID’, ‘phase shift’, etc.

In another example, a RS or RS set may be associated with a CSI-RS, e.g., a CSI-RS configuration or a CSI-RS index. Multiple RS or RS sets may be associated with the same CSI-RS. Multiple CSI-RS may be configured to be associated with different RS or RS sets. The UE measures the CSI-RS configured to be associated with the different RS or RS sets. The UE compares the measurement results, e.g., RSRP, SINR, pathloss, etc. of the CSI-RS, and may determine to measure the RS or RS set(s) that are associated with the best measurement result(s) for NF beam selection. The best measurement result(s) here may refer to the best one or multiple measurement(s) that has the highest RSRP, the highest SINR, or the lowest pathloss. The best measurement result(s) here may also refer to one or multiple measurement(s) that is above or below a configured measurement threshold value.

### Configuration of Mapping Between CSI Reporting and Selection Function Input

There may also be an association between CSI reporting for NF beam selection and selection function input.

The UE may receive configuration information that associates one or more configurations of CSI reporting for NF beam selection with one or more selection function inputs. The UE determines the measurement result of the configured selection function input and determines the RS or RS set that is associated with the measured result for NF beam selection. For example, a CSI reporting configuration is associated with one or more selection function inputs and corresponding set(s) of input values.

In one example, a CSI reporting configuration for NF beam selection may be associated with one or more distance values or one or more distance ranges. A distance range may be configured through the value of the lower bound of the distance range and the value of the upper bound of the distance range. The distance range may also be configured through the value of the lower bound of the distance range and the value of the difference between the lower bound and the upper bound. The distance range may be configured through the value of the upper bound of the distance range and the value of the difference between the lower bound and the upper bound. Several distance ranges may be configured to be associated with multiple CSI reporting configurations respectively. These distance ranges may be uniformly distributed, i.e., the difference between the lower bound and the upper bound for different distance ranges are the same. In this case, a step size or a value of the difference may be configured to be applied to all the distance ranges. The distance ranges may be non-uniformly distributed, i.e., the difference between the lower bound and the upper bound for different distance ranges are the different. In this case, separate step size or separate value of the difference may be configured for the distance ranges respectively.

The notion in the previous paragraph may also be applied to other selection function input metrics. For example, instead of ‘distance,’ the notion can work with ‘RSRP’, ‘SINR’, ‘pathloss’, ‘zone ID’, ‘phase shift’, etc.

In another example, a CSI-RS reporting configuration for NF beam selection may be associated with a CSI-RS, e.g., a CSI-RS configuration or a CSI-RS index. Multiple CSI-RS may be configured to be associated with different CSI-RS reporting configurations. The UE measures the CSI-RS configured to be associated with the different CSI-RS reporting configurations. The UE compares the measurement result, e.g., RSRP, SINR, pathloss, etc. of the CSI-RS, and may determine to measure the CSI-RS reporting configuration that is associated with the best measurement result(s) for reporting the selected NF beam(s) or reporting the preferred NF beam(s). The best measurement result(s) here may refer to the best one or multiple measurement(s) that has the highest RSRP, the highest SINR, or the lowest pathloss. The best measurement result(s) here may refer to one or multiple measurement(s) that is above or below a configured measurement threshold value.

### UE Determination of Selection Function Input

### UE Determination of Explicit Distance Information

The UE may determine the explicit distance information, e.g., focus distance or a distance between a TRP and the UE, as the measured selection function input for example based on one or more of positioning and/or sensing mechanisms and measurement of a configured reference signal, e.g., CSI-RS, SSB, pathloss reference signal, etc. In the latter case, the UE measures the configured reference signal, e.g., measures the RSRP, SINR, pathloss, phase shifts between antenna ports, and uses the measurement result to determine the distance information. In one example, the UE may be configured with a mapping between the measurement results and the corresponding distance information, and the UE can determine the distance information as the distance associated with the measured RSRP, SINR, pathloss, phase shifts between antenna ports, etc. In another example, the UE may autonomously determine the distance information based on the measured RSRP, SINR, pathloss, phase shifts between antenna ports, etc.

### UE Determination of Implicit Distance Information

The UE may be configured with a reference signal, for example CSI-RS, e.g., periodic CSI-RS, semi-persistent CSI-RS, aperiodic CSI-RS, to determine the RSRP or SINR. The UE measures the RSRP or SINR of the configured CSI-RS and determines the measured selection function input.

The UE may be configured with a pathloss reference signal, e.g., CSI-RS or SSB, and its transmission power to determine the pathloss. The UE measures the pathloss of the configured pathloss reference signal and determines the measured selection function input.

The UE may be configured with a multi-port CSI-RS to determine the phase shift(s) between antenna ports. The UE may measure multi-port CSI-RSs and estimate the channel conditions e.g., phase shifts, of different antenna ports. The UE may determine the maximum, average, or median, etc., measured phase shift between antenna ports as the measured selection function input.

For example, a region may be divided into multiple zones each of which is associated with a zone ID. The UE may receive an indication of the zone ID in which it is located. The UE may also determine its the zone ID information based on positioning and/or sensing. The UE may also be configured with one or more reference signal and derive its zone information from the measurement of the configured reference signal, e.g., RSRP, SINR, pathloss, etc. The UE can then use the determined zone ID as the measured selection function input.

### UE Determination of Non-Distance Information

The UE may be configured with multiple CSI-RS, where each CSI-RS is associated with a direction or angular information. The UE measures the configured CSI-RS and determines the preferred direction or angle(s) based on the measured RSRP. The UE then uses the determined preferred direction or angle(s) as the measured selection function input.

The UE may be configured with multiple CSI-RS, where each CSI-RS is associated with one or more selection configuration, e.g., RS or RS set, CSI-reporting configuration, etc. The UE measures the, for example, RSRP or SINR, of configured the CSI-RS and compares the measurement results. The UE may then use the comparison result as the measured selection function input.

### UE Determination of FF Beam Selection or NF Beam Selection

In a region where both a NF beam and an FF beam are provided to serve the UE, the gNB and/or UE need to determine which whether to use the NF beam or the FF beam for communication. The gNB or UE also needs to determine which NF beam or FF beam to use. In NR, the UE is configured with CSI-RS for beam management, e.g., a first set of CSI-RS, for selecting the FF beam. According to the present principles, to support NF, the UE may configure a second set of CSI-RS for NF beam selection. FF beam selection may for example include one or more of performing measurements on the first set of CSI-RS, selecting one or more CSI-RS from the first set based on the measurements result(s), reporting the measurement results, reporting the selected one or more CSI-RS, etc. NF beam selection may for example include one or more of performing measurements on the second set of CSI-RS, selecting one or more CSI-RS from the second set based on the measurements result(s), reporting the measurement results, reporting the selected one or more CSI-RS, etc. The UE may determine whether to perform FF beam selection or NF beam selection using one or any combination of the following techniques.

### UE Determines Whether to Select FF Beam or NF Beam Based on Explicit Distance Information

In an embodiment, the UE may determine whether to perform FF beam selection or NF beam selection based on measured distance. The UE may determine to perform FF beam selection if measured distance is above a configured threshold value. The UE may determine to perform NF beam selection if measured distance is below a configured threshold value. The UE may determine to perform NF beam selection if measured distance falls within a configured range of distances associated with NF beam selection.

### UE Determines Whether to Select FF Beam or NF Beam Based on Implicit Distance Information

In an embodiment, the UE may determine, using one or more techniques, whether to perform FF beam selection or NF beam selection based on one or more measurements indicating implicit distance information. The UE may determine to perform FF beam selection if measured RSRP/SINR is below a configured threshold value. The UE may determine to perform FF beam selection if measured RSRP/SINR falls within a configured range associated with FF beam selection. The UE may determine to perform NF beam selection if measured RSRP/SINR is above a configured threshold value. The UE may determine to perform NF beam selection if measured RSRP/SINR falls within a configured range associated with NF beam selection. The UE may determine to perform FF beam selection if measured pathloss is above a configured threshold value. The UE may determine to perform FF beam selection if measured pathloss falls within a configured range associated with FF beam selection. The UE may determine to perform NF beam selection if measured pathloss is below a configured threshold value. The UE may determine to perform NF beam selection if measured pathloss falls within a configured range associated with NF beam selection.

### UE Determines Whether to Select FF Beam or NF Beam Based on UE Measurement of Multi-Port CSI-RSs

In an embodiment, the UE may measure multi-port CSI-RSs and estimate the channel conditions of different antenna ports. Then, the UE may determine whether to perform FF beam selection or NF beam selection based on the calculated phase shift between different antenna ports in a number of ways. The UE may determine to perform FF beam selection if the maximum calculated phase shift between antenna ports is below a configured threshold value. The UE may determine to perform FF beam selection if the maximum calculated phase shift between antenna ports falls with a configured range associated with FF beam selection. The UE may determine to perform NF beam selection if maximum calculated phase shift between antenna ports is above a configured threshold value. The UE may determine to perform NF beam selection if maximum calculated phase shift between antenna ports falls with a configured range associated with NF beam selection.

### UE Determines Whether to Select FF Beam or NF Beam Based on Relative Measurements of FF-Based CSI-RS and NF-Based CSI-RS

In an embodiment, a UE may be configured with two sets of CSI-RS for determining whether to perform FF beam selection or NF beam selection. For example, the UE may be configured with a first set of CSI-RS that contains one or more FF-based CSI-RS, and a second set of CSI-RS that contains one or more NF-based CSI-RS. By measuring and comparing the two set of CSI-RS, the UE may make the determination on FF beam selection or NF beam selection.

For example, the UE may measure one or more FF-based CSI-RS and one or more NF-based CSI-RS and may then determine whether to perform FF beam selection or NF beam selection based on the relative measurements between the FF-based CSI-RS and NF-based CSI-RS

The UE may determine to perform FF beam selection if the difference between the maximum measured SINR/RSRP on NF-based CSI-RS and the maximum measured SINR/RSRP on FF-based CSI-RS is below a threshold value or falls within a configured range associated with FF beam selection. The UE may determine to perform FF beam selection if the ratio between the maximum measured SINR/RSRP on FF-based CSI-RS and the maximum measured SINR/RSRP on NF-based CSI-RS is above a threshold value or falls within a configured range associated with FF beam selection. The UE may determine to perform NF beam selection if the difference between the maximum measured SINR/RSRP on NF-based CSI-RS and the maximum measured SINR/RSRP on FF-based CSI-RS is above a threshold value or falls within a configured range associated with NF beam selection. The UE may determine to perform NF beam selection if the ratio between the maximum measured SINR/RSRP on FF-based CSI-RS and the maximum measured SINR/RSRP on NF-based CSI-RS is below a threshold value or falls within a configured range associated with NF beam selection. The UE may determine to perform FF beam selection if the measured SINR/RSRP on FF-based CSI-RS is greater than the measured SINR/RSRP on NF-based CSI-RS. The UE may determine to perform NF beam selection if the measured SINR/RSRP on NF-based CSI-RS is greater than the measured SINR/RSRP on FF-based CSI-RS.

### UE Determines Whether to Select FF Beam or NF Beam Based on Detected Region

In an embodiment, the UE may detect its region NF or FF based on one or more measurements and may the determine whether to perform FF beam selection or NF beam selection based on the detected region in different ways. The UE may determine to perform FF beam selection if it detects that it's in the FF region. The UE may determine to perform NF beam selection if it detects that it's in the NF region. The UE may determine to perform FF beam selection if it detects zone ID associated with FF region (zone ID falls within a range of zone ID associated with FF region). The UE may determine to perform NF beam selection if it detects zone ID associated with NF region (zone ID falls within a range of zone ID associated with NF region).

### UE Determines Whether to Select FF Beam or NF Beam Based QoS Requirements

In an embodiment, the UE may determine whether to perform FF beam selection or NF beam selection based on one or more metrics indicating QoS requirements. For example, the UE may determine to perform NF beam selection if one or more metrics indicating QoS requirements are above corresponding configured threshold values (required reliability above a threshold value, required throughput above a threshold value, etc.). In another example, the UE may determine to perform FF beam selection if one or more metrics indicating QoS requirements are below corresponding configured threshold values (required reliability below a threshold value, required throughput below a threshold value, etc.).

### UE Reporting of Assistance Information for Configuration Selection Function

Once the UE determines the measured selection function input, the UE may, in one example, report assistance information, e.g., which is generated based on the measured selection function input, to the gNB to help the gNB in its determination, for example, determining to transmit or turn on and off which CSI-RS for the UE to do NF beam selection. After selecting the NF beam, the UE transmits another reporting to the gNB to report the selected/preferred NF beam. Such behavior is herein referred to as 2-stage reporting.

In another example, the UE may abstain from reporting assistance information to the gNB after determining the measured selection function input and only report the selected/preferred NF beam(s) to the gNB after finishing the NF beam selection. Such behavior is herein referred to as 1-stage reporting.

### UE Determination of Reporting Resource for Reporting the Assistance Information

In one example, the UE may determine the reporting configuration based on the measured selection function input. The UE may be configured with multiple selection configurations, e.g., CSI reporting configurations, where each selection configuration may be associated with one or more of selection function input metrics. The UE may determine the selection configuration to be used for reporting the assistance information based on the relationship between the measured selection function input and the configured selection function input metrics. For example, when the measured selection function input belongs to a configured selection function input metrics, e.g., when the measured RSRP belongs to a RSRP range, the UE uses the associated selection configuration, e.g., CSI reporting configuration, to report the assistance information.

In another example, the UE may determine the reporting configuration based on the comparison of the measured selection function input, e.g., comparison of the measured CSI-RS. The UE may be configured with multiple selection configurations, e.g., CSI reporting configurations, where each selection configuration may be associated with one or more selection function input, e.g., CSI-RS. The UE may compare the measured RSRP or SINR of the multiple configured CSI-RS and determine to use the selection configuration that is associated with the CSI-RS that has the best measurement result for reporting the assistant information.

In another example, The UE may be explicitly configured or provided with the reporting configuration used to report the assistance information. For example, the UE may be signaled with a CSI reporting for reporting the assistance information through a RRC, a MAC-CE, or a DCI. The UE uses the signaled CSI reporting to report the assistance information.

The UE may report one or more of the following items of information as the assistance information. One or more of preferred RS index and preferred RS set index; the UE determines the preferred RS index or preferred RS set index based on the measured selection function input; for example, when the measured selection function input falls into a configured input metric and the RS or RS set that is associated with the input metric or value is a preferred RS or RS set. One or more of determined distance range or distance value, e.g., index of the determined distance range or index of distance value. One or more of determined pathloss range and pathloss value, e.g., index of the determined pathloss range or index of pathloss value. One or more of determined RSRP/SINR range and RSRP/SINR value, e.g., index of the determined RSRP/SINR range or index of RSRP/SINR value. One or more of determined phase shift range and phase shift value, e.g., index of the determined pathloss range that the max phase shift falls into or index of the max phase shift value.

One or more of determined zone ID range and zone ID value, e.g., index of the determined zone ID range or index of zone ID value. One or more and CSI-RS index. For example, the UE may be configured with multiple CSI-RS, each associated with one or more RS or with one or more RS set and the UE measures the configured CSI-RS and compares the measurement results and determines the best measurement result(s) and reports the associated CSI-RS index.

UE Behavior after Reporting the Assistance Information

After sending the report carrying the assistance information, the UE may start to monitor the determined RS or RS set for NF beam selection directly. However, to allow the gNB to receive the reported assistance information and adjust the CSI-RS to be transmitted, the UE may start to monitor the determined RS or RS set after receiving a trigger from the gNB or wait for a pre-configured time.

In one example, the UE may be configured with a processing time T₁, e.g., the number of milliseconds or the number of one or a combination of symbols, slots, mini-slots, frames, etc., for the UE to wait before starting to monitor the determined RS or RS set. The UE may start to monitor the determined RS or RS set the first slot after the processing time T₁ has elapsed.

### Configuration of RS Measurement/Reporting Delay

While the UE is in RRC_CONNECTED state, it may receive a downlink (DL) RRC signaling. The DL RRC signaling includes at least a time duration. The time duration indicates a value with a unit of milliseconds, symbols, slots, sub-slots or subframes. It is noted that the value of the time duration may be interpreted in different units as already described. The DL RRC signaling can include multiple time durations, each associated with a specific BWP or serving cells. The DL RRC signaling can include a first time duration and a second time duration, where the first time duration is associated with a default Bandwidth Part (BWP) and the second time duration is associated with all other BWPs. The DL RRC signaling can include a first time duration and a second time duration, where the first time duration is associated with a primary Cell (e.g., special cell (SpCell)) and the second time duration is associated with all secondary cells (SCell(s)).

### Determination of RS Measurement/Reporting Triggering

After the UE reports the assistance information to the gNB, it may start to perform RS measurement. Specifically, the UE may determine to start to perform RS measurement when a time duration counted from when the UE reports assistance information to the gNB has elapsed. More specifically, the UE may determine to start to perform RS measurement when a time duration indicated by the DL RRC signaling counted from when the UE reports assistance information to the gNB has elapsed. More specifically, the UE may start to perform RS measurement in a first symbol, slot, sub-slot or subframe after a time duration indicated by the DL RRC signaling counted from when the UE reports assistance information to the gNB has elapsed.

In one embodiment, the UE starts a timer in response to having reported the assistance information to the gNB. The UE may start to perform RS measurement (in a first symbol, slot, sub-slot or subframe after a time duration indicated by the DL RRC signaling) in response to expiry of the timer (i.e., when a corresponding time has elapsed). The initial value of the timer is set to the time duration indicated by the DL RRC signaling.

In one embodiment, the UE receives a confirmation message from the gNB in response to the assistance information reporting. The UE may determine to start to perform RS measurement based on either the reception of the confirmation message and/or the time duration elapsed since the UE reported the assistance information. For example, the UE may determine to start to perform RS measurement after receiving the confirmation message. In another example, in case the UE has not received the confirmation message, it may determine to start to perform RS measurement after the time duration counted from when the UE reported the assistance information has elapsed. In another example, the UE may determine to start to perform RS measurement upon reception of the confirmation message before the time duration counted from when the UE reports assistance information elapsed.

In another embodiment, the UE may start a timer in response to having reported the assistance information to the gNB. The UE may start to perform RS measurement (in a first symbol, slot, sub-slot or subframe of a current active DL BWP after a time duration indicated by the DL RRC signaling) in response to the timer has elapsed. The initial value of the timer is set to the time duration indicated by the DL RRC signaling.

In further embodiment, the UE may restart the time in case of a BWP switching has been performed after the UE assistance information has been reported.

After having reported the assistance information to the gNB, the UE may start to perform measurement reporting. Specifically, the UE may determine to start to perform measurement reporting after a time duration counted from when the UE reported the assistance information to the gNB has elapsed. More specifically, the UE may determine to start to perform measurement reporting after a time duration indicated by the DL RRC signaling and counted from when the UE reported the assistance information to the gNB has elapsed. The measurement reporting provides the measurement results of the RS measurements to the gNB. More specifically, the UE may start to perform measurement reporting in a first symbol, slot, sub-slot or subframe after a time duration indicated by the DL RRC signaling and counted from when the UE reported assistance information to the gNB has elapsed.

In one embodiment, the UE may receive a confirmation message from the gNB in response to the assistance information reporting. The UE may determine to start to perform measurement reporting based on either the reception of the confirmation message and/or when the time duration counted from when the UE reported the assistance information has elapsed. For example, the UE may determine to start to perform measurement reporting after the UE receives the confirmation message. In another example, in case the UE has not received the confirmation message, it may determine to start to perform measurement reporting when the time duration counted from when the UE reported the assistance information has elapsed. In another example, the UE may determine to start to perform measurement reporting if the UE receives the confirmation message before the time duration counted from when the UE reported the assistance information has elapsed.

In one embodiment, the UE may start a timer upon having reported the assistance information to the gNB. The UE may start to perform measurement reporting (in a first symbol, slot, sub-slot or subframe after a time duration indicated by the DL RRC signaling) in response to expiry of the timer. The initial value of the timer is set to the time duration indicated by the DL RRC signaling.

In another embodiment, the UE may start a timer upon having reported the assistance information to the gNB. The UE may start to perform measurement reporting (in a first symbol, slot, sub-slot or subframe of a current active DL BWP after a time duration indicated by the DL RRC signaling) in response to expiry of the timer. The initial value of the timer is set to the time duration indicated by the DL RRC signaling.

In further embodiment, the UE may restart the timer in case BWP switching has been performed after the UE assistance information has been reported.

### UE Determination of RS or RS Set for NF Beam Selection

The configured set of CSI-RS may include a number of configured CSI-RS, which may correspond to different NF beams and/or FF beams. Since the measurement of a CSI-RS may be associated with a UE effort, it may be beneficial for the UE to perform measurements on a subset of the configured set of CSI-RS, instead of on the whole configured set. Furthermore, if the network knows that the UE performs measurements only on a subset, the network may turn off the transmission of one or more CSI-RS in the configured set of CSI-RS that are not in the CSI-RS subset.

Let [symbol] denote a set of CSLRS that the UE shall divide into CSI-RS subsets. The number of CSI-RS in the set [symbol] may be denoted [symbol] . The number [symbol] may be explicitly configured or implicitly configured, e.g., by the number of configured CSI-RS that are configured such that they should be included in [symbol] . The set [symbol] may correspond to the configured set of CSI-RS. The set [symbol] may be a subset of the configured set of CSI-RS, e.g., the set of [symbol] CSI-RS in the configured set of CSI-RS that are configured to be included in the set [symbol] . In one example, the UE may determine the set [symbol] as the [symbol] configured CSI-RS with lowest or highest CSI-RS Ids. In another example, each CSI-RS in [symbol] is configured such that it shall be included in [symbol] , e.g., by being configured with an optional parameter, such as a CSI-RS Id cᵢ, where for instance i=1 . . . [symbol] , or a parameter with a parameter value corresponding to inclusion in [symbol] .

Let [symbol] denote CSI-RS subset j. Let [symbol] denote the number of CSI-RS subsets, e.g., j=1=. . . [symbol] .

Let Nⱼ denote the number of CSI-RS in CSI-RS subset j. The CSI-RS subsets may be disjoint of overlapping. The union of the CSI-RS subsets may be equal to [symbol] or less than (i.e., not include some elements of) [symbol] . In one example, the CSI-RS subsets are disjoint, and the union equals [symbol] . In another example, the CSI-RS subsets are overlapping, and the union equals [symbol] .

In the context of FIG. 4, the [symbol] CSI-RS subsets correspond to the set of selection configurations. The mapping between selection function inputs and CSI-RS subsets (see section “Configuration of Mapping between RS/RS set and selection function input” hereinafter) corresponds to the configuration selection function. The UE determination of the selected CSI-RS subset (see section “UE determination of selected CSI-RS subset”) corresponds to the determination of the selected configuration.

### UE Determination of CSI-RS Subsets

The UE determination of CSI-RS subsets can be based on explicit CSI-RS subset configuration. In one example, the UE is provided with an explicit configuration of which CSI-RS that are included in each CSI-RS subset, e.g., as described in sections “RS or RS set configuration” and “Configuration of Mapping between RS/RS set and selection function input”. Hence, the UE may determine the CSI-RS subsets based on the configuration. Alternatively, the UE may determine the CSI-RS subsets based on its configuration, e.g., based on one or more parameters, and/or one or more pre-configured parameters. This may be seen as an implicit configuration of the CSI-RS subsets. Both the UE and network may determine the CSI-RS subsets based on the parameters.

### UE Determination of CSI-RS Subsets Based on CSI-RS Indices

In an example of implicit configuration of CSI-RS subsets, the UE may determine the subsets based on one or more of the following parameters that may be configured, pre-configured, or otherwise determined by the UE: the number of CSI-RS, [symbol] , the CSI-RS Ids cᵢ of the CSI-RS in [symbol] , where for instance i=1, . . . [symbol] , the number of CSI-RS subsets, [symbol] , the (e.g., nominal or actual) number of CSI-RS per CSI-RS subset, M, and the starting CSI-RS index of one or more CSI-RS subsets, sⱼ.

As for cᵢ, without loss of generality, it may be assumed that cᵢ<cᵢ₊₁ for all i=1, . . . , ( [symbol] −1), i.e., that the CSI-RS indices [symbol] in are unique and ordered. The UE may determine the CSI-RS indices i based on the corresponding CSI-RS Ids cᵢ. However, the UE might not need to determine the CSI-RS indices i to perform the methods described herein. For instance, a number of consecutive CSI-RS indices i, i+1, etc., may correspond to non-consecutive CSI-RS Ids cᵢ, cᵢ₊₁, etc. For simplicity of presentation, however, CSI-RS indices, e.g., i=1, . . . , [symbol] , may be used herein.

When it comes to the number of CSI-RS per CSI-RS subset, M, in some cases, the determined number of CSI-RS in each determined CSI-RS subset equals M, i.e., Nⱼ=M for each subset j. In other cases, the determined number of CSI-RS in some determined CSI-RS subset equals M, while not equaling M in the other determined CSI-RS subsets, as will be further described.

Additional parameters for configuration/pre-configuration may be described herein. As described above, a CSI-RS subset may be associated with an Ids or index, e.g., j=1, . . . , [symbol] . The Id or index may be determined by the UE, e.g., as described hereinafter, or configured. Thereby, CSI-RS subsets may be ordered, e.g., according to the subset index j.

The UE may determine disjoint CSI-RS subsets based on the CSI-RS Ids (and/or corresponding CSI-RS indices) and the number of CSI-RS per CSI-RS subset, M.

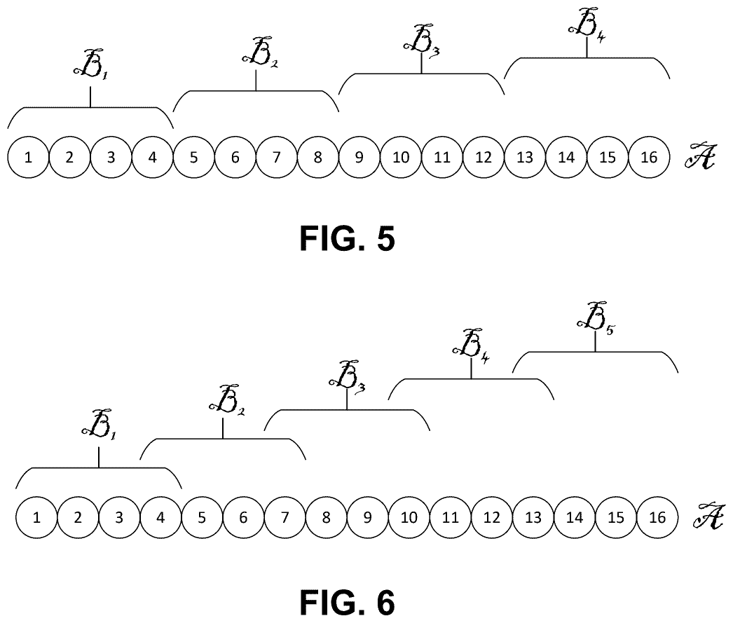

In one example, the UE may determine the subsets by including M CSI-RS with consecutive CSI-RS indices in a subset. Thereby, each determined CSI-RS subset include M CSI-RS, at least when M divides [symbol] . If M does not divide [symbol] , one or more CSI-RS subsets, e.g., the CSI-RS subset with highest subset Id or the subset including the CSI-RS with highest indices, may include less than M CSI-RS. For instance, a first CSI-RS subset may include CSI-RS with indices i=1, . . . , M, the second CSI-RS subset may include CSI-RS with indices i=M+1, . . . , 2M, and so on. An example of disjoint subsets [symbol] =16 and M=4 is illustrated in FIG. 5.

In a similar example, the UE determines the disjoint CSI-RS subsets by including every [symbol] /M (or every └ [symbol] /M┘ or ┌ [symbol] /M┐ if M does not divide [symbol] ) CSI-RS. For instance, a first CSI-RS subset may comprise CSI-RS with indices

$$i = 1 , 1 + \frac{{N}_{𝒜}}{M} , … , 1 + ( M - 1 ) {N}_{𝒜} / M ,$$

the second CSI-RS subset may comprise CSI-RS with indices

$$i = 2 , 2 + \frac{{N}_{𝒜}}{M} , … , 2 + ( M - 1 ) {N}_{𝒜} / M ,$$

and so on.

The number of disjoint subsets, [symbol] , is typically smaller than the number of CSI-RS, [symbol] , at least if the number of CSI-RS per subset, M, is greater than one.

If the CSI-RS subsets are disjoint, e.g., as described hereinbefore, a CSI-RS belongs to a single subset. While this may provide a simple mapping between a CSI-RS and the associated CSI-RS subset, e.g., the single subset to which it belongs, it may result in various issues. For example, if the CSI-RS in a CSI-RS subset corresponds to a set of spatially adjacent NF beams, some CSI-RS may correspond to a NF beam that is spatially on the edge of the set of spatially adjacent NF beams. Therefore, it may be beneficial to consider overlapping CSI-RS subsets.

The UE may determine overlapping CSI-RS subsets based on the CSI-RS Ids, the number of CSI-RS per CSI-RS subset, M, and the number of CSI-RS subsets, [symbol] .

In one example, the CSI-RS subsets comprise CSI-RS with consecutive CSI-RS indices. For example, the UE may determine overlapping CSI-RS subsets such that they are uniformly (if possible) or nearly uniformly spread out among the NA CSI-RS indices. In one example, a first CSI-RS subset, e.g., with j=1, comprises M consecutive CSI-RS indices starting at i=1, a second CSI-RS subset, e.g., with j=2 comprises M consecutive indices starting at i=1+D, a j^{th} CSI-RS subset comprises M consecutive indices starting at i=1+(j−1)D, wherein D is a subset offset. For example,

$$D = \frac{{N}_{𝒜} - M}{{N}_{ℬ} - 1} .$$

If [symbol] −1 doesn't divide [symbol] −M, a variation example includes the rounding, rounding up, or rounding down, of

$$\frac{{N}_{𝒜} - M}{{N}_{ℬ} - 1}$$

An example of overlapping subsets with [symbol] =16, [symbol] =5 and M=4, which gives D=3 is illustrated in FIG. 6.

The network may determine which transmission schemes to use for which CSI-RS. For instance, in the case of NF beams, the network may transmit CSI-RS with lower indices with lower focus distance (or pathloss, etc.) and CSI-RS with higher indices with higher focus distance (or pathloss, etc.), and in some cases with FF beams (e.g., infinite focus distance). In one example, a mapping between low determined UE distance and CSI-RS subset(s) including CSI-RS with low CSI-RS indices may be appropriate and may be configured or pre-configured.

The examples herein may be extended to include wraparound of CSI-RS indices, for instance by including a mod- [symbol] (modulo) operation, e.g., with mod- [symbol] ( [symbol] )= [symbol] and mod- [symbol] ( [symbol] +1)=1. In other words, CSI-RS indices may be consecutive with wrap around, e.g., i= [symbol] −1, [symbol] , 1, 2 may be considered four consecutive CSI-RS indices.

One example, e.g., with index wraparound, may use

$$D = \frac{{N}_{𝒜}}{{N}_{ℬ}} , D = ⌈ \frac{{N}_{𝒜}}{{N}_{ℬ}} ⌉ , or D = ⌊ \frac{{N}_{𝒜}}{{N}_{ℬ}} ⌋ .$$

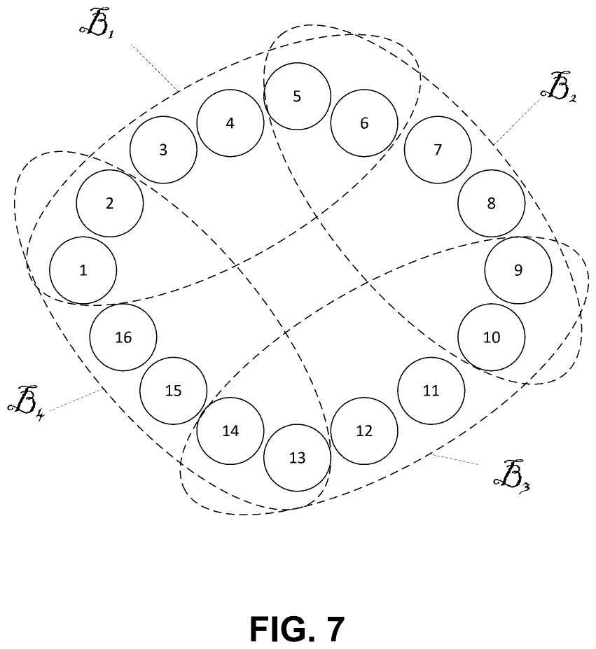

example of overlapping subsets and index wraparound with [symbol] =16, [symbol] =4, which gives D=4, and M=6 is illustrated in FIG. 7.

In one example, the number of CSI-RS subsets, [symbol] , is equal to the number of CSI-RS, [symbol] , which gives the subset offset

$$D = \frac{{N}_{𝒜}}{{N}_{ℬ}} = 1 ,$$

i.e., the starting indices of two subsequent CSI-RS subsets among the NB CSI-RS subsets are offset by 1.

The UE may determine CSI-RS subsets based on grids and CSI-RS Indices.

In various examples already described, a CSI-RS may have two immediately adjacent CSI-RS, based on CSI-RS indices. For example, in FIG. 7, CSI-RS with index 1 has CSI-RS with indices 2 and 16 as immediate neighbors. Similarly, the CSI-RS subsets may be defined based on adjacent indices, in various examples.

It is noted that CSI-RS may correspond to NF beams, and that it may be beneficial to include CSI-RS corresponding to spatially adjacent NF beams in a CSI-RS subset. From this perspective, it may be beneficial to design subsets based on a grid structure, e.g., a 2D grid or a 3D grid.

In an example, a 2D grid, in which a first dimension may correspond to an angle and a second dimension may correspond to a distance, is used. In another example, a 2D grid, in which a first dimension may correspond to a first angle and a second dimension may correspond to a second angle, is used.

A 2D grid may be defined by two parameters, E₁ and E₂, which may correspond to the number of points in the two dimensions. In other words, the total number of points in the grid may correspond to E₁E₂. In one example, both E₁ and E₂ are configured in the UE. In another example, either E₁ or E₂ is configured, and the other parameter is determined by the UE, for instance, E₂=

$$\frac{{N}_{𝒜}}{{E}_{1}}$$

(with rounding, e.g., rounding up, if needed). From one perspective, a 2D grid may be represented by an E₁×E₂ matrix. An index e₁ may represent the first grid dimension (e.g., rows) and an index e₂ may represent the second grid dimension (e.g., columns).

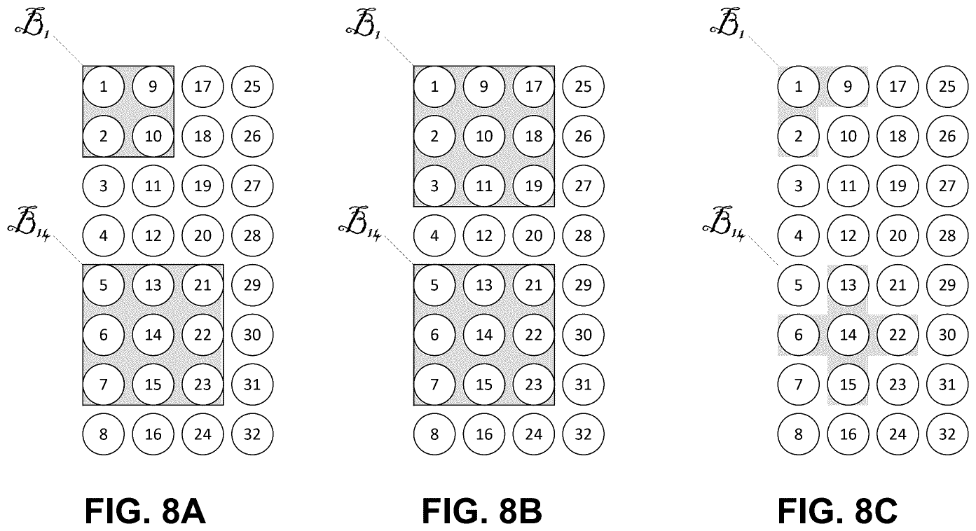

The UE may assign the [symbol] CSI-RS to grid points based on the corresponding CSI-RS indices. For example, the first E₁ CSI-RS indices (e.g., i=1, . . . , E₁) may be assigned to the grid points with e₁=1, . . . , E₁ and e₂=1, etc. Examples of CSI-RS assigned to 2D grid points, with [symbol] =32, E₁=8, and E₂=4, are illustrated in FIGS. 8A-8C.

The UE may determine CSI-RS based on the determined grid, e.g., based on CSI-RS indices that are adjacent in the grid.

The UE may determine a CSI-RS subset corresponding to a reference CSI-RS index based on the set of CSI-RS indices that are adjacent to the reference CSI-RS. For instance, a j^{th} CSI-RS subset may be determined by the UE as the set of CSI-RS that are adjacent to a reference i^{th} CSI-RS index. In a non-limiting example used herein, in which a CSI-RS subset may be determined for each (reference) CSI-RS index, the j^{th} CSI-RS subset may be determined by the UE as the set of CSI-RS that are adjacent to the reference j^{th} CSI-RS index.

In a first example method, the UE may determine the j^{th} CSI-RS subset as the j^{th} CSI-RS index and also the CSI-RS indices immediately adjacent to it in the grid (e.g., without or with wraparound). This may result in different subset sizes. For example, as illustrated in FIG. 8A, the 1^{st} CSI-RS subset (j=1) may comprise four elements, while the 14^{th} subset (j=14) may comprise nine elements.

In a second example method, the UE may determine the j^{th} CSI-RS subset as the j^{th} CSI-RS index and also the M−1 CSI-RS indices closest to it in the grid. In case of multiple equally close grid points, the UE may consider one of the dimensions as closer (at least for the purpose of determining subsets), e.g., the first or the second. For example, as illustrated in FIG. 8B, both the 1^{st} CSI-RS subset and the 14^{th} subset comprise nine elements (M=9). Multiple CSI-RS subsets may be equal, e.g., [symbol] ₁ and [symbol] ₂ in the example illustrated in FIG. 8B. In some cases, the equal subsets may be considered the same (single) subset.

In the first example method, the distance between the reference CSI-RS and the furthest CSI-RS is the same in the different subsets. In the second example method, the distance may be different in different subsets, but the number of elements in the subset is the same.

In the previous examples, adjacent elements with different grid indices in each dimension than the grid indices of the reference CSI-RS may be included in the corresponding subset. For instance, CSI-RS indices 5, 21, 7, and 23, are included in [symbol] ₁₀ even though they have different grid indices than the reference CSI-RS index 14 in each dimension. In other words, the CSI-RS are diagonally adjacent, rather than horizontally or vertically adjacent. In another example, the diagonally adjacent CSI-RS indices are not included in the corresponding subset, as illustrated in FIG. 8C. Only adjacent CSI-RS with the same grid index as the reference CSI-RS in at least one dimension are included.

In other examples, CSI-RS indices not only immediately adjacent to the reference CSI-RS may be included in the subset, but also CSI-RS indices separated by two or more steps in the grid. The determination of CSI-RS may be based on inclusion of diagonally adjacent CSI-RS for the CSI-RS separated by the lowest number of steps (e.g., CSI-RS separated by one step from the reference), while diagonally adjacent CSI-RS might not be included in the corresponding subset for the highest number of steps (e.g., CSI-RS separated by two steps from the reference).

In an example, a 3D grid, in which a first dimension may correspond to a first angle a second dimension may correspond to a second angle and a third dimension may correspond to a distance, is used.

A 3D grid may be defined through three parameters, E₁, E₂, and E₃, which may correspond to the number of points in the three dimensions. In other words, the total number of points in the grid may correspond to E₁E₂E₃. In one example, E₁, E₂, and E₃ are configured in the UE. In another example, only two parameters, e.g., E₁ and E₂ are configured, and the third parameter is determined by the UE, for instance,

$${E}_{3} = \frac{{N}_{𝒜}}{{E}_{1} {E}_{2}}$$

(with rounding, e.g., rounding up, if needed). Indices e₁, e₂, e₃, may represent the grid points.

The UE may assign the [symbol] CSI-RS to grid points based on the corresponding CSI-RS indices. For example, the first E₁ CSI-RS indices (e.g., i=1, . . . , E₁) may be assigned to the grid points with e₁=1, . . . , E₁ and e₂=e₃=1, etc.

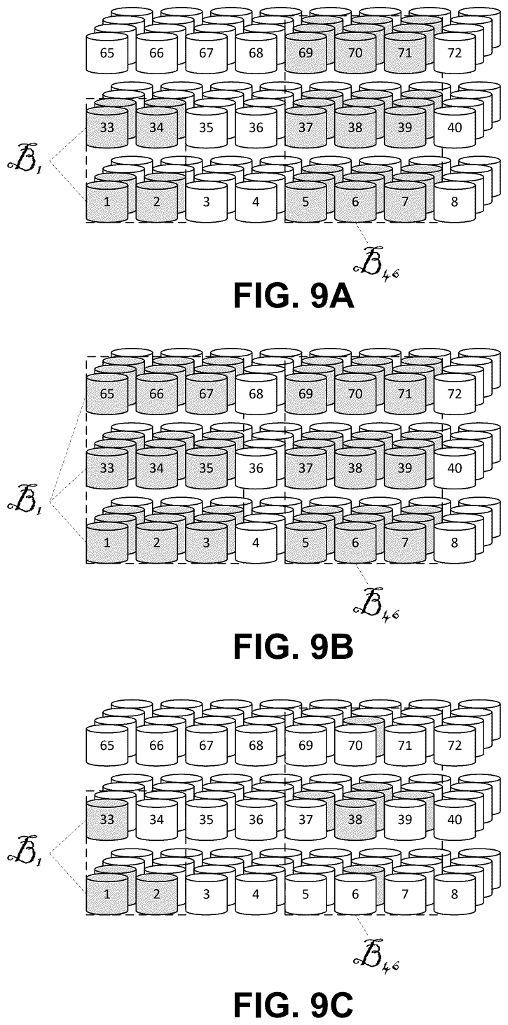

Examples of CSI-RS assigned to 3D grid points are illustrated in FIGS. 9A-9C. Following the first example method (described hereinbefore), as illustrated in FIG. 9A, the 1^{st} CSI-RS subset (j=1) may comprise 8 elements, while the 46^{th} subset may comprise 27 elements.

Following the second example method (described hereinbefore), as illustrated in FIG. 9B, both the 1st CSI-RS subset and the 46th subset include 27 elements (M=27).

FIG. 9C illustrates the example with diagonally adjacent elements not being included in the corresponding subset.

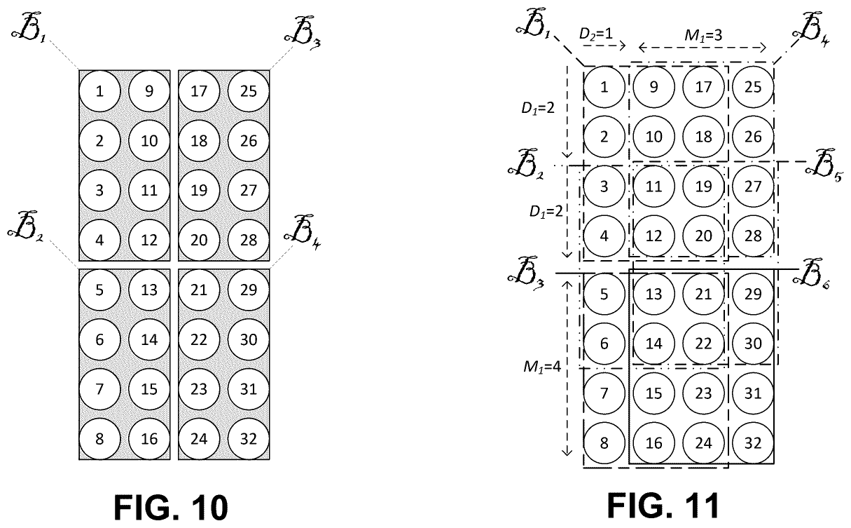

In other examples, the UE may determine disjoint CSI-RS subsets based on a grid, e.g., 2D or 3D grid. The UE may be configured with the subset size per dimension, e.g., per the two dimensions in a 2D grid or per the three dimensions in a 3D grid. For the example 2D grid with disjoint CSI-RS subsets, as illustrated in FIG. 10, a UE may for example be configured with a CSI-RS subset size of 4 in the first dimension and a CSI-RS subset size of 2 in the second dimension, with a combined CSI-RS subset size of 8. The 2D method and illustrated example readily generalize to a 3D grid.

The UE may determine overlapping CSI-RS subsets based on a 2D grid or 3D grid, the number of CSI-RS per CSI-RS subset per dimension, e.g., M₁ and M₂ in the case of 2D, or M₁, M₂ and M₃ in the case of 3D, and the number of CSI-RS subsets per dimension, e.g., [symbol] and [symbol] in the case of 2D, or [symbol] , [symbol] and [symbol] in the case of 3D. The corresponding parameter(s) may be configured or pre-configured.

In one example, the CSI-RS subsets comprise CSI-RS that are consecutive in each dimension. For example, the UE may determine overlapping CSI-RS subsets such that they are uniformly (if possible) or nearly uniformly spread out among the CSI-RS per dimension. In one example, a first CSI-RS subset, e.g., with j₁=1, includes M₁ consecutive CSI-RS starting at the first CSI-RS in the first dimension, a second CSI-RS subset in the first dimension, e.g., with j₁=2 comprises M₁ consecutive indices starting at CSI-RS 1+D₁ (in the first dimension), a j₁^{th} CSI RS subset in the first dimension includes M₁ consecutive CSI-RS starting at CSI-RS 1+(j₁−1)D₁ (in the first dimension), wherein D₁ is a subset offset (in the first dimension). For example,

$${D}_{1} = \frac{{E}_{1} - {M}_{1}}{{N}_{ℬ1} - 1} .$$

If [symbol] −1 doesn't divide E₁−M₁, a variation example includes the rounding, rounding up, or rounding down, of

$$\frac{{E}_{1} - {M}_{1}}{{N}_{ℬ1} - 1} .$$

The 2D subset may be obtained by combining the different combinations of subsets in each dimension, e.g., combining the different j₁ with the different j₂ in 2D, or combining the different j₁, j₂, and j₃, with 3D grids.

An example illustration of overlapping subsets based on a 2D grid is shown in FIG. 11, with E₁=8, M₁=4, [symbol] =3, which gives D₁=2, and E₂=4, M₂=3, [symbol] =2, which gives D₂=1. Since [symbol] =3 and [symbol] =2, the number of CSI-RS subsets is [symbol] = [symbol] [symbol] =6. The example subsets are B₁: {1-4, 9-12, 17-20}, B₂: {3-6, 11-14, 19-22}, B₃: {5-8,13-16, 21-24}, B₄: {9-12, 17-20, 25-28}, B₅: {11-14, 19-22, 27-30}, B₆: {13-16, 21-24, 29-32}. The 2D method and illustrated example readily generalize to a 3D grid.

The parameters used to determine the CSI-RS subsets may be known to both the UE and the network, e.g., if the parameters were configured by the network to the UE. Hence, the subsets may be known to both the UE and the network.

The network may transmit the CSI-RS using NF and/or FF beams such that spatially close beams, e.g., NF beams, are close also in the 2D or 3D grid, or in the CSI-RS index-based order. Hence, the network can make the CSI-RS in a CSI-RS subset correspond to spatially close beams. In the 3D grid example, the 3D-cans illustrating different CSI-RS indices may correspond to NF spot beams, which may have a 3D beam shape, e.g., a 3 dB beam shape, e.g., the 3D space with beam gain within 3 dB from the maximum beam gain.

With the UE-determined CSI-RS subsets, it is possible to define a large number of CSI-RS subsets without the need for explicit configuration. In one numerical example with 1000 beams ( [symbol] =1000), a CSI-RS subset per beam ( [symbol] =1000), and 27 CSI-RS per subset (M=27), an explicit configuration of all subsets would comprise 27,000 CSI-RS indices. Instead, in the methods herein, only a few parameters need to be configured, depending on the detailed method, thereby saving a significant overhead.

In some cases, one or more CSI-RS may be associated with various properties, e.g., through configuration, such as one or more angles, distance(s), zone ID(s), near field region(s), far field region(s), etc.

The UE may determine CSI-RS subsets based on one or more of the CSI-RS properties. For instance, a UE may assign CSI-RS to subsets with similar one or more properties.

In an example, a UE may determine CSI-RS subsets based on a combination of CSI-RS index and one or more CSI-RS properties, e.g., distance. For instance, the UE may determine a grid, e.g., 2D or 3D, based on grouping CSI-RS with the same or similar property value or range in the same index in a dimension. For instance, the UE may put the CSI-RS associated with the smallest distance(s) in e₁=1, etc., and the CSI-RS associated with the largest distance(s) in e₁=E₁. The assignment of CSI-RS to grid points in the other dimensions may be based on another property, or a CSI-RS index. For instance, the CSI-RS assigned to e₁=1 may be assigned to grid points with e₂=1, . . . , E₂ based on the CSI-RS index order.

For one example, the CSI-RS may be associated with distance values (or ranges). The UE may assign CSI-RS that have the same (or similar or adjacent) distance values to the same subset.

For another example, the CSI-RS may be associated with distance and angle values (or ranges). The UE may assign CSI-RS that have the same (or similar or adjacent) distance values and angle values to the same subset.

In various examples, CSI-RS subsets are based on configured, activated, and/or indicated QCL relations. For instance, CSI-RS with the same source RS may be included in the same CSI-RS subset.

### Mapping Between Selection Function Input and CSI-RS Subsets

As also described in section “Configuration of Mapping between RS/RS set and selection function input”, different selection function inputs may be associated with different RS sets, e.g., CSI-RS subsets.

In one example, the UE may determine the mapping based on CSI-RS indices in CSI-RS subsets. For a selection function input including an input CSI-RS index from a set of measured CSI-RS, e.g., a set of measured CSI-RS, the set of CSI-RS may be equal to or a subset of the configured CSI-RS, the CSI-RS in A, etc.

The input CSI-RS index may for instance correspond to the CSI-RS in the set of measured CSI-RS with highest/best measurement result.

The input CSI-RS index may be mapped to a CSI-RS subset through CSI-RS subset in which it is included. With disjoint CSI-RS subsets, a CSI-RS index is included in no more than one subset. Hence, input CSI-RS index i is mapped to the CSI-RS subset j that includes CSI-RS index i.

In another example, e.g., in which the number of CSI-RS subsets is equal to the number of CSI-RS (e.g., [symbol] = [symbol] ), input CSI-RS index i is mapped to CSI-RS subset i.

In various examples, the selection function input is a metric other than a CSI-RS index. A UE may for instance use a CSI-RS property used to determine CSI-RS subsets to determine the mapping between selection function input value(s) and CSI-RS subsets. For example, the UE may determine CSI-RS subsets based on distance values associated with CSI-RS. The UE may determine a mapping between an input in the form of a distance measurement value and a CSI-RS subset based on the distance value(s) or distance range(s) of the CSI-RS in the subsets. Alternatively, input values or ranges may be mapped to CSI-RS subsets in order of value or range and in order of CSI-RS subset index. For instance, lowest input values may be mapped to lowest CSI-RS subset index, etc. The mapping between input values/ranges and subsets may also be configured to the UE.

In some cases, a UE may determine one or more CSI-RS indices based on a selection function input that is not a CSI-RS index, e.g., a distance value. The UE may then use the one or more CSI-RS indices to determine a CSI-RS subset, e.g., a CSI-RS subset that is mapped to the determined one or more CSI-RS indices. In other words, in some examples, a CSI-RS index may act as an intermediate parameter between a non-index input and a selected CSI-RS subset.

It is noted that, in general, the present principles consider one-to-one, multiple-to-one, and/or one-to-multiple mapping between input values/ranges and CSI-RS subsets.

It is noted that the UE may determine the CSI-RS subsets prior to determining the selection function input, or upon selection function input. For instance, upon determination of input CSI-RS index i, the UE may determine the subset to which CSI-RS index i is mapped.

### UE Determination of Selected CSI-RS Subset

Based on the mapping between the selection function input and CSI-RS subset, and a selection function input, the UE can select a selected configuration, e.g., a selected CSI-RS subset.

### UE Measurement of Selected CSI-RS Subset

Upon CSI-RS subset selection, the UE may perform measurements on the CSI-RS in the CSI-RS subset, e.g., for NF beam selection. For instance, based on the measurements, the UE may select one or more CSI-RS from the CSI-RS subset, e.g., for reporting.

### UE Determination of CSI Reporting Configuration for Reporting the Selected NF Beam

Once the selected or preferred NF beam is determined, the UE reports this information (i.e., regarding the selected beams) to the gNB using CSI reporting. The UE may determine the CSI reporting configuration to be used based on one of more of the ways.

In one way, the UE may determine the CSI reporting configuration based on the measured selection function input. The UE may be configured with multiple selection configurations, e.g., CSI reporting configurations, where each selection configuration may be associated with one or more selection function input metrics. The UE may determine the selection configuration to be used for reporting the selected or preferred NF beam based on the relationship between the measured selection function input and the configured selection function input metrics. For example, when the measured selection function input belongs to a configured selection function input metric, e.g., when the measured RSRP/SINR/pathloss belongs to a RSRP/SINR/pathloss range, the UE uses the associated selection configuration, e.g., CSI reporting configuration, to report the selected or preferred NF beam.

In another way, the UE may determine the CSI reporting configuration based on the comparison of the measured selection function input, e.g., comparison of the measured CSI-RS. The UE may be configured with multiple selection configurations, e.g., CSI reporting configurations, where each selection configuration may be associated with one or more selection function input, e.g., CSI-RS. The UE may compare the measured RSRP or SINR of the multiple configured CSI-RS and determine to use the selection configuration that is associated with the CSI-RS that has the best measurement result for reporting the selected or preferred NF beam.

In another way, the UE may determine the CSI reporting configuration based on the RS or RS set that is determined for NF beam selection. The UE may be configured with multiple selection configurations, e.g., CSI reporting configurations, where each selection configuration may be associated with one or more RS or RS set. Upon determination of the RS or RS set for NF beam selection, the UE determines to use the associated CSI reporting configuration for reporting the selected or preferred NF beam.

In another way, the UE may be explicitly configured or indicated with the CSI reporting configuration used to report the selected or preferred NF beam. For example, UE may be signaled with a CSI reporting for reporting the selected or preferred NF beam through an RRC, a MAC-CE, or a DCI. The UE uses the signaled CSI reporting to report the selected or preferred NF beam.

### UE Reporting for the Selected NF Beam

The UE may report one or any combination of the following to indicate selected NF beam(s) using the determined CSI reporting: DL RS set/subset index, index of a determined pathloss range (e.g., indicating a reference DL RS set/subset), index of a determined distance range (e.g., indicating a reference DL RS set/subset), index of a determined RSRP/SINR range (e.g., indicating a reference DL RS set/subset), one or more local DL RS index of selected beam(s) (where the indices are local within a reference reported DL RS set/subset, a reference reported and confirmed DL RS set/subset, a DL RS set associated with CSI report, a DL RS set associated with a determined/reported pathloss range, a DL RS set associated with a determined/reported distance range, a DL RS set associated with a determined/reported RSRP/SINR range), one or more global DL RS index of selected beam(s), and one or more measurements associated with reported beam(s).

### UE Reports the Selected NF Beam Based on 1-Stage Reporting

In an embodiment, the UE may report the selected NF beam based on 1-stage reporting approach through reporting an indicator for a reference DL RS set/subset and local index of the DL RS associated with the selected beam (the index is local within the reference DL RS set/subset). The UE may send one of the following to indicate the reference RS set/subset: a DL RS set/subset index, an index of a determined pathloss range associated with the reference DL RS set/subset, an index of a determined distance range associated with the reference DL RS set/subset, and an index of a determined RSRP/SINR range associated with the reference DL RS set/subset).

Alternatively, UE may report the selected NF beam through reporting global index of the DL RS associated with the selected NF beam.

### UE Reports One or More Candidate NF Beams Based on 1-Stage Reporting

In an embodiment, the UE may report one or more candidate NF beams based on 1-stage reporting approach through reporting the following parameters: an indicator for a reference DL RS set/subset where this indicator can be reported using one or more of the already listed reporting methods (e.g., DL RS set/subset index, Index of a determined pathloss range associated with the reference DL RS set/subset index, etc.), local indices of the DL RSs associated with the candidate beams (the indices are local within the reference DL RS set/subset), and one or more measurements associated with the candidate beams (e.g., measured RSRP/SINR for each candidate beam).

### UE Reports the Selected NF Beam Based on 2-Stage Reporting

In an embodiment, the UE may report the selected NF beam based on 2-stage reporting approach through reporting

local index of the DL RS associated with the selected beam. The reported index is local within previously indicated RS set/subset and confirmed by to the NW

### UE Reports One or More Candidate NF Beams Based on 2-Stage Reporting

In a solution, UE may report one or more candidate NF beams based on 2-stage reporting approach through reporting local indices of the DL RSs associated with the candidate beams, where the reported indices are local within previously indicated RS set/subset and confirmed by the NW, and or one or more measurements associated with the candidate beams (e.g., measured RSRP/SINR for each candidate beam).

UE Reports the Selected NF Beam in CSI Report Associated with a Certain DL RS Subset/Set, e.g., Pathloss Range, SINR/RSRP Range, Distance Range, Etc.

In an embodiment, the UE may report the selected NF beam in a CSI report associated with a certain DL RS subset/set (e.g., pathloss range, SINR/RSRP range, distance range, etc.) through reporting a local index of the DL RS associated with the selected beam, where the reported index is local within RS set/subset associated with the CSI report.

UE Reports One or More Candidate NF Beams in CSI Report Associated with a Certain DL RS Subset/Set, e.g., Pathloss Range, SINR/RSRP Range, Distance Range, Etc.

In an embodiment, the UE may report one or more candidate NF beams in a CSI report associated with a certain DL RS subset/set (e.g., pathloss range, SINR/RSRP range, distance range, etc.) through reporting local indices of the DL RSs associated with the candidate beams, where the reported indices are local within RS set/subset associated with the CSI report, and/or one or more measurements associated with the candidate beams (e.g., measured RSRP/SINR for each candidate beam).

### UE Reports Global Index Reflecting the Selected NF Beam

In an embodiment, the UE may report the global index of the DL RS associated with the selected NF beam.

### UE Reports Global Indices of Candidate NF Beam

In an embodiment, the UE may report global indices of the DL RSs associated with the candidate beams and one or more measurements associated with the candidate beams (e.g., measured RSRP/SINR for each candidate beam).

### Example Solutions

In an embodiment, the UE measures received power of a received first downlink, DL, reference signal, RS received from a network and, upon determination that a value based on the measured received power satisfies at least one first criterion, determines a value range to which the value belongs, determines a set of second DL RS associated with the determined value range, measures the determined set of second DL RS to obtain a corresponding set of first measurement results, selects a DL RS from the set of second DL RS based on the set of first measurement results, and transmits, to the network, information indicative of at least one of the selected DL RS and the corresponding first measurement result.

Upon determination that the value based on the measured received power does not satisfy the criteria, the UE can measure a set of third DL RS signal to obtain a corresponding set of second measurement results, select a DL RS from the set of third DL RS based on the second measurement result, and transmit, to the network, information indicative of at least one of the selected DL RS and the corresponding second measurement result.

The UE can further determine a reporting configuration associated with the determined value range, wherein the information is transmitted using the reporting configuration.

The set of second DL RS correspond to near-field beams.

The at least one first criterion can be satisfied in case the measured received power is below a given value, for example in case the value based on the measured received power relates to pathloss.

The at least one first criterion can be satisfied in case the measured received power is above a given value, for example in case the value based on the measured received power is the measured received power.

The UE can further measure received power of a plurality of received fourth DL RS and, after measuring the received power of the first DL RS, select the first DL RS from the plurality of fourth DL RS, based on their corresponding measured received powers.

The first DL RS be disjunct from the set of second DL RS or be part of the set of second DL RS.

The UE can further transmit information indicative of the value range. The UE can measure the determined set of second DL RS is performed in response to a trigger event, e.g. reception of a trigger message. Measuring of the determined set of second DL RS can be performed after expiry of a given time interval after reception of the trigger message.

The present principles will now be further described through a number of illustrative methods.

### Distance-Based RS Determination and CSI Reporting Determination for NF Beam Selection

Summary: The UE is configured with multiple sets of reference signals representing near-field (associated with different distances represented by different pathloss ranges) and far-field beams. The UE is configured with multiple CSI reporting configurations (associated with different distances represented by different pathloss ranges) for near-field. The UE estimates its pathloss and selects a set of RS to measure for beam selection based on the estimated pathloss. The UE selects a CSI reporting based on the estimated pathloss to report the measurement result.

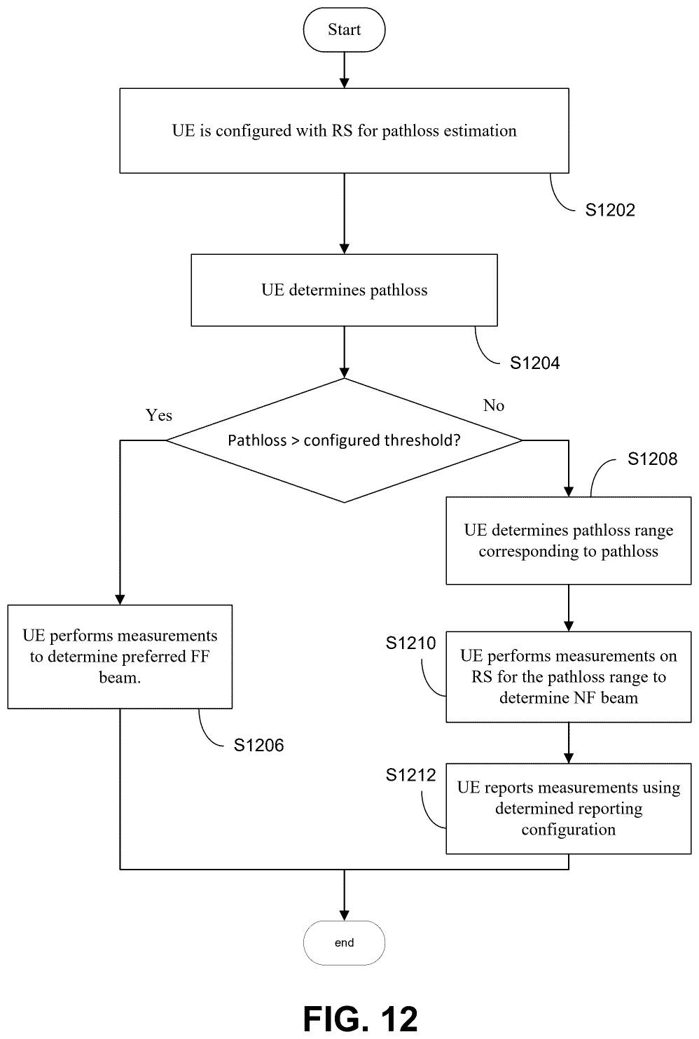

FIG. 12 illustrates an example flowchart of a method of distance-based RS determination and CSI reporting determination for NF beam selection according to an embodiment. It is noted that, in this example, pathloss is used as an example, and that the proposed embodiment can be also used other configuration selection inputs, such as focus distance, RSRP, SINR, zone ID, phase shift, etc.

In step S1202, the UE is configured with RS for pathloss estimation. The configuration can include one or more of a first DL RS and corresponding DL RS transmit power for pathloss estimation, multiple pathloss ranges (e.g. with threshold values), a set of a second DL RS for near-field beam selection, (wherein each second DL RS is associated with one or more configured pathloss ranges), a set of a third DL RS for far-field beam selection, multiple CSI reporting configurations (each associated with a configured pathloss range).

In step S1204, the UE performs an initial pathloss estimation using the first configured DL RS and determines the pathloss. (Depending on the implementation, the UE may report the determined pathloss to the gNB or not).

In case the determined pathloss is above a configured threshold value, in step S1206, the UE performs a second measurement using the third configured RS signal to determine the far-field beam and the method ends.

In case the determined pathloss is below the configured threshold value, in step S1208, the UE determines the pathloss range corresponding to the determined pathloss. The UE determines the CSI reporting configuration that is associated with the determined pathloss range.

In step S1210, the UE determines a subset of the configured second DL RS that are associated with the determined pathloss range and measures the determined subset of second DL RS to determine the near-field beam.

In step S1212, the UE reports the measurement result using the determined CSI reporting configuration.

Non-Distance-Based RS Determination for NF Beam Selection with 1-Stage Reporting

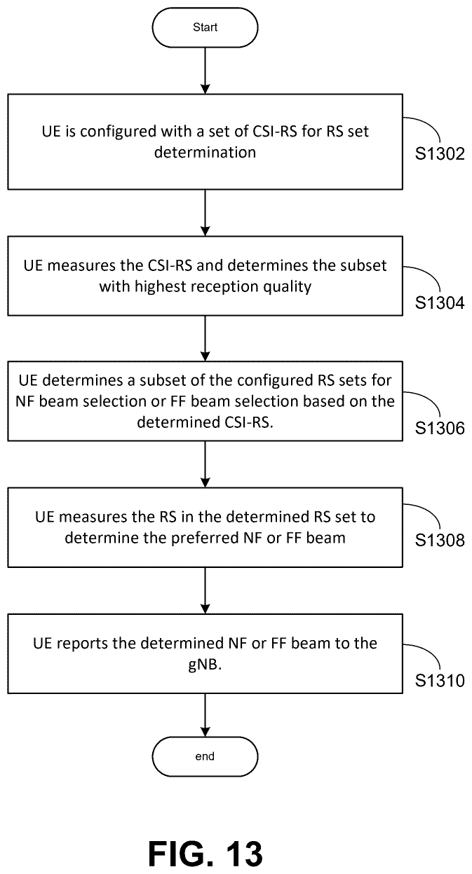

Summary: Different DL RS sets, which are used for NF beam sweeping, are associated with different CSI-RS. The UE determines one DL RS set out of (e.g., all) the configured RS sets to measure based on the comparison of the measured CSI-RS to reduce the effort on RS measurement for NF beam sweeping and to save latency. FIG. 13 illustrates an example flowchart of a method for non-distance-based RS determination for NF beam selection with 1-stage reporting according to an embodiment.

In general, the UE measures received powers of a first set of received downlink, DL, reference signals, RS, selects a first DL RS from the first set based on the measured received powers, determines a second set of DL RS that is associated with the first DL RS, measures the determined second set of DL RS to obtain respective measurement results, determines a RS based on the measurement results, and transmits information indicative of at least one of the determined RS and the respective measurement results.

In step S1302, the UE is configured with a set of CSI-RS for DL RS set determination, multiple DL RS sets/subsets for NF beam selection or for FF beams selection, and multiple 1-to-1 associations between the CSI-RS and the DL RS set/subset.

In step S1304, the UE measures the set of CSI-RS and determines their RSRP. In one example, the UE determines the subset of CSI-RS with the highest reception quality, e.g. that has the highest RSRP or has the RSRP higher than a configured threshold value. In another example, the UE further compares the RSRP measured by the CSI-RS associated with the DL RS set/subset that is used for NF beam selection, e.g., RSRP_{NF}, and the RSRP measured by the CSI-RS associated with the DL RS set/subset that is used for FF beam selection e.g., RSRP_{FF}. If the RSRP_{NF}−RSRP_{FF}>RSRP_{threshold1}, the CSI-RS associated NF beam selection is determined; otherwise, the CSI-RS associated FF beam selection is determined, where RSRP_{threshold1} is a threshold predefined in the specification or configured by the gNB. In yet another example, if the RSRP_{FF}−RSRP_{NF}>RSRP_{threshold2}, the CSI-RS associated FF beam selection is determined; otherwise, the CSI-RS associated NF beam selection is determined, where RSRP_{threshold2} is a threshold predefined in the specification or configured by the gNB

In step S1306, the UE determines the DL RS set/subset that is associated with the determined CSI-RS for performing the NF beam selection or for FF beams selection.

In step S1308, the UE measures the DL RS in the determined DL RS set/subset and obtains a measurement result used to determine a preferred CSI-RS, i.e. NF or FF beam.

In step S1310, the UE reports the index of the determined CSI-RS and the measurement result for the DL RS set associated with the determined CSI-RS.

Distance-Based RS Determination for NF Beam Selection with 1-Stage Reporting

Summary: different DL RS sets, which are used for NF beam sweeping, are associated with different pathloss ranges. The UE determines one DL RS set out of all the configured RS sets to measure based on the estimated pathloss to reduce the effort on RS measurement for NF beam sweeping and save latency.

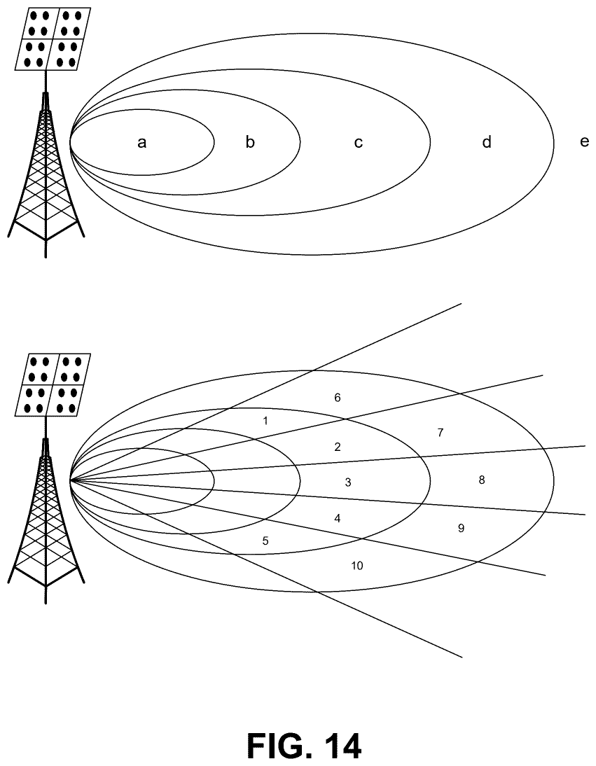

FIG. 14 illustrates an example of association between pathloss range and RS set. In the figure, RS set 3, including RS 1, 2, 3, 4, and 5, is associated with pathloss range c, and RS set 4, including RS 6, 7, 8, 9, 10, is associated with pathloss range d. It is again noted that, in this example, pathloss is used as an example, the proposed method can also use other configuration selection inputs, such as focus distance, RSRP, SINR, zone ID, phase shift, etc.

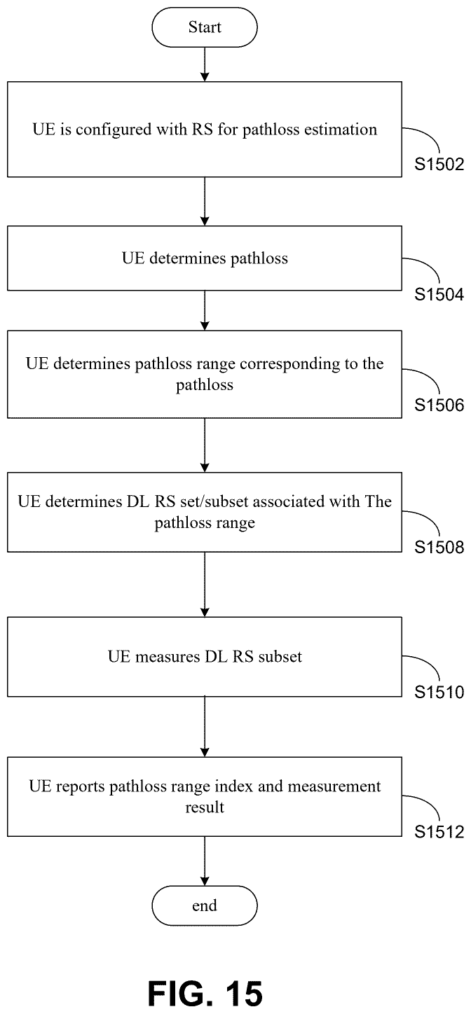

FIG. 15 illustrates an example flowchart of a method for distance-based RS determination for NF beam selection with 1-stage reporting according to an embodiment.

In step S1502, the UE is configured with DL RS 1 and corresponding DL RS 1 transmit power (where DL RS 1 is transmitted through an omni-direction beam or a wide beam), multiple pathloss ranges (pathloss a/b/c/d/e etc.), multiple DL RS sets/subsets (RS set 1, 2, 3, 4, 5, etc.), and multiple 1-to-1 associations between the pathloss range and the DL RS set/subset.

In step S1504, the UE measures DL RS 1 and determines DL RS 1 pathloss.

In step S1506, the UE determines the pathloss range corresponding to the determined DL RS 1 pathloss.

In step S1508, the UE determines the DL RS set/subset that is associated with the determined pathloss range.

In step S1510, the UE measures, for example the RSRP of, the DL RS in the determined DL RS set/subset and determines a measurement result.

In step S1512, the UE reports the index of the determined pathloss range (a/b/c/d/e) and the measurement result, e.g. the RS index, (1/2/3/4/5) for the DL RS set associated with the pathloss range.

Distance-Based RS Determination for NF Beam Selection with 2-Stage Reporting

Summary: Different DL RS sets, which are used for NF beam sweeping, are associated with different pathloss ranges. The UE reports the estimated pathloss to the gNB to assist the gNB determining which CSI-RS to transmit. The UE determines one DL RS set out of all the configured RS sets to measure based on the estimated pathloss to reduce the effort on RS measurement for NF beam sweeping and save latency.

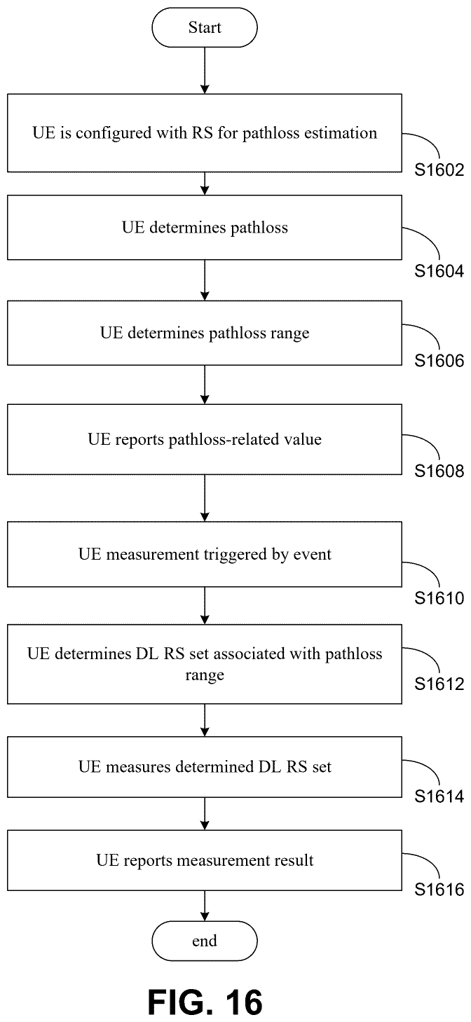

FIG. 16 illustrates an example flowchart of distance-based RS determination for NF beam selection with 2-stage reporting. It is again noted that, in this example, pathloss is used as an example, and that the proposed method can also use other configuration selection inputs, such as focus distance, RSRP, SINR, zone ID, phase shift, etc.

In step S1602, the UE is configured with the DL RS 1 and corresponding DL RS 1 transmit power (where the DL RS 1 is transmitted through omni-direction beam or wide beam), multiple pathloss ranges, multiple DL RS sets/subsets, and multiple 1-to-1 associations between the pathloss range and the DL RS set/subset.

In step S1604, the UE measures DL RS 1 and determines DL RS 1 pathloss.

In step S1606, the UE determines the pathloss range corresponding to the determined DL RS 1 pathloss.

In step S1608, the UE reports a pathloss-related value to the gNB, for example an index of the determined pathloss range (e.g., pathloss range c) or the measured pathloss.

In step S1610, an event triggers measurement. The event can be reception by the UE of a confirmation that the gNB has received the reporting, or expiry of a time T₁ counted from transmission of the reporting (in which case no confirmation from gNB is needed).

In step S1612, the UE determines the one out of the multiple DL RS sets which is associated with the determined pathloss range to measure.

In step S1614, the UE measures the DL RS (1/2/3/4/5) in the determined DL RS set and determines a measurement result.

In step S1616, the UE reports the measurement result (1/2/3/4/5) for the DL RS set associated with the pathloss range.

Distance-Based CSI Reporting Determination and RS Set Determination for NF Beam Selection with 2-Stage Reporting

Summary: different CSI reporting configurations, which are linked to different RS sets, are associated with different pathloss ranges. The UE determines CSI reporting configuration based on the estimated pathloss. The UE only measures the RS set that is associated with the determined CSI reporting configuration to reduce the effort on RS measurement for NF beam sweeping and save latency.

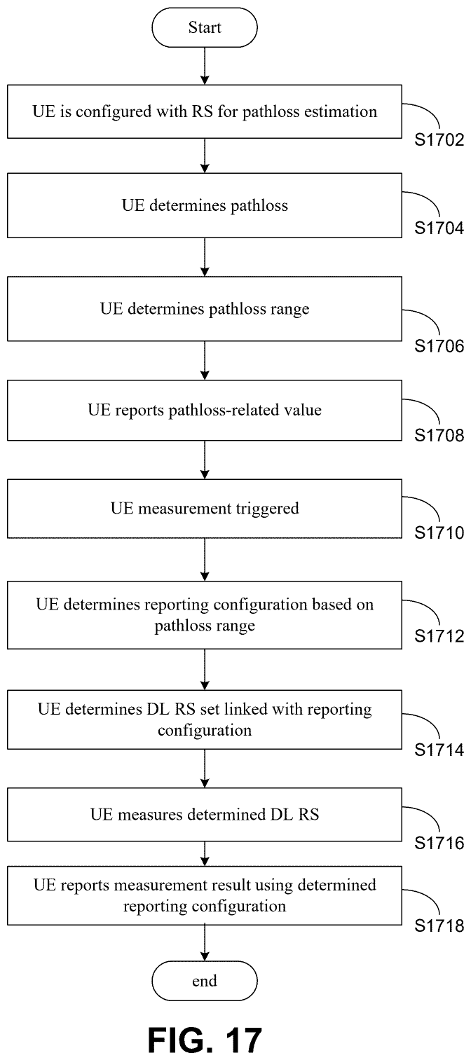

FIG. 17 illustrates an example flowchart of a method for distance-based CSI reporting determination and RS set determination for NF beam selection with 2-stage reporting. It is again noted that, in this example, pathloss is used as an example, and that the proposed method can also use other configuration selection inputs, such as focus distance, RSRP, SINR, zone ID, phase shift, etc.

In step S1702, the UE is configured with the DL RS 1 and corresponding DL RS 1 transmit power (where the DL RS 1 is transmitted through omni-direction beam or wide beam), multiple pathloss ranges, multiple DL RS sets/subsets, multiple CSI reporting configurations, each linked with a DL RS set/subset, and multiple 1-to-1 associations between the pathloss range and the CSI reporting configuration.

In step S1704, the UE measures DL RS 1 and determines DL RS 1 pathloss.

In step S1706, the UE determines the pathloss range corresponding to the determined DL RS 1 pathloss.

In step S1708, the UE reports a pathloss-related value to the gNB, for example an index of the determined pathloss range (e.g., pathloss range c) or the measured pathloss.

In step S1710, an event triggers measurement triggering. The event can be reception at the UE of a confirmation that the gNB has received the reporting, or expiry of a time T₁ counted from transmission of the reporting (in which case there is no need for a confirmation from the gNB).

In step S1712, the UE determines the CSI reporting configuration that is associated with the determined pathloss range.

In step S1714, the UE determines the DL RS set that is linked with the determined CSI reporting configuration.

In step S1716, the UE measures the DL RS in the determined DL RS set and determines a measurement result.

In step S1718, the UE reports the measurement result (e.g., 1/2/3/4/5) for the DL RS set associated with the pathloss range using the associated CSI reporting configuration.

Distance and Direction-Based RS Determination and CSI Reporting Determination for NF Beam Selection with 1-Stage Reporting

Summary: multiple DL RS are configured for NF beam sweeping. Each DL RS is associated with one or more pathloss ranges and one or more directions. The UE determines and forms a set of DL RS to measure for determining the preferred NF beam based on the measured pathloss and the corresponding direction to reduce the effort on RS measurement for NF beam sweeping and save latency.

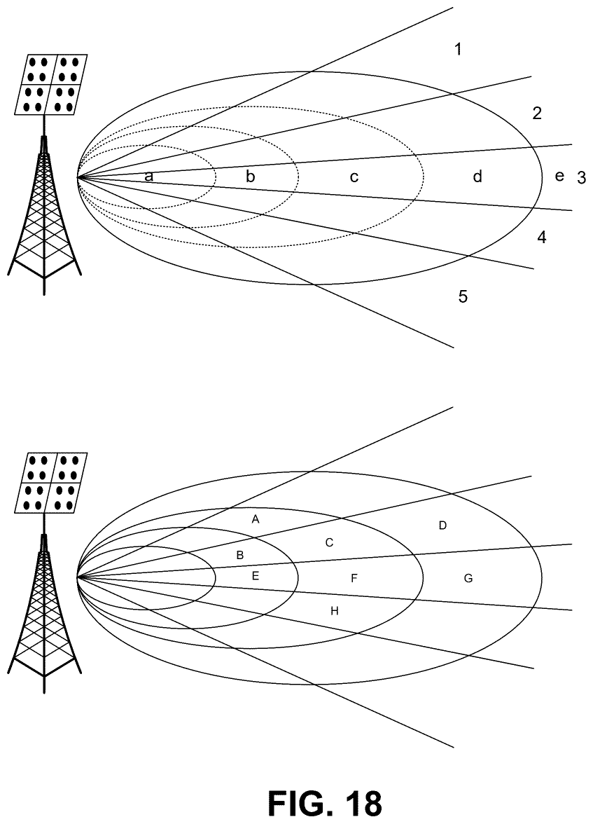

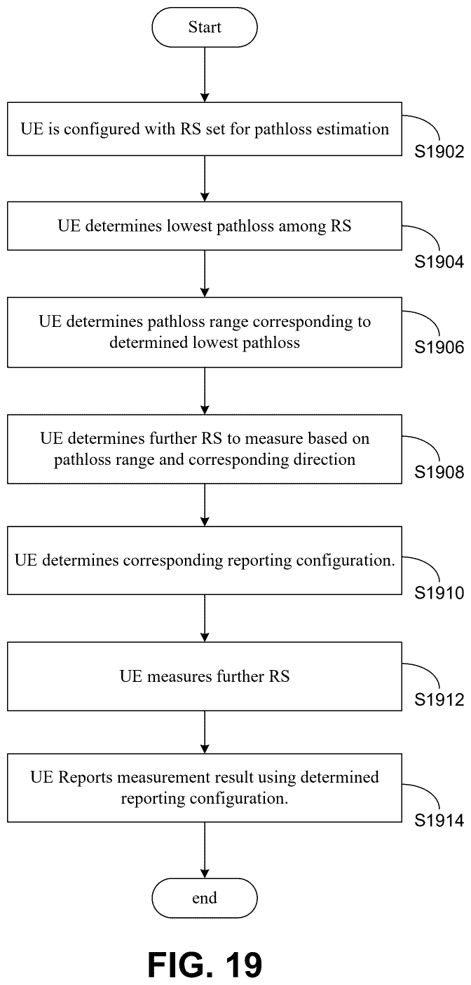

FIG. 18 illustrates an example of association between RS and a combination of pathloss range and direction. It is again noted that, in this example, pathloss is used as an example, and that the proposed method can also use other configuration selection inputs, such as focus distance, RSRP, SINR, zone ID, phase shift, etc. FIG. 19 illustrates an example flowchart of a method for distance and direction-based RS determination and CSI reporting determination for NF beam selection with 1-stage reporting.

In step 1902, the UE is configured with DL RS set 1 and corresponding DL RS transmit power (where each RS (e.g., CSI-RS 1, . . . , 5 in FIG. 18) in DL RS set 1 is transmitted through narrow beams and is associated with one direction (e.g., QCL type-D in direction 1, 2, . . . , 5 in FIG. 18)), multiple pathloss ranges (e.g., range a, b, . . . , e in FIG. 18), multiple DL RS 2 (e.g., CSI-RS A, B, . . . , H in FIG. 18) (where each DL RS 2 is associated with one or more pathloss ranges and one or more directions (DL RS 1)), multiple CSI reporting configurations, and multiple 1-to-1 associations between the CSI reporting configuration and a combination of pathloss range and direction.

In step S1904, the UE measures RS in DL RS set 1 and determines the lowest RS pathloss.

In step S1906, the UE determines the pathloss range corresponding to the determined lowest pathloss.

In step S1908, the UE determines a set (e.g., set 2c, 3c) of DL RS 2 to measure based on the determined pathloss range and the corresponding direction.

In step S1910, the UE determines the CSI reporting configuration that is associated with the determined pathloss range and determined direction

In step S1912, the UE measures the set of the determined DL RS 2 and determines a measurement result. For example, the UE can measure RSRP and determine the DL RS with the highest RSRP.

In step S1914, the UE reports the measurement result (e.g., local index of the preferred DL RS 2) using the determined CSI reporting configuration.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method at a wireless transmit/receive unit, WTRU, the method comprising:
measuring received power of a received first downlink, DL, reference signal, RS, received from a network;
upon determination that a value based on the measured received power satisfies at least one first criterion:
determining a value range to which the value belongs;
determining a set of second DL RS associated with the determined value range;
measuring the determined set of second DL RS to obtain a corresponding set of first measurement results;
selecting a DL RS from the set of second DL RS based on the set of first measurement results; and
transmitting, to the network, information indicative of at least one of the selected DL RS and the corresponding first measurement result.

2. The method of claim 1, further comprising:
upon determination that the value based on the measured received power does not satisfy the at least one first criterion:
measuring a set of third DL RS signal to obtain a corresponding set of second measurement results;
selecting a DL RS from the set of third DL RS based on the second measurement result; and
transmitting, to the network, information indicative of at least one of the selected DL RS and the corresponding second measurement result.

3. The method of claim 1, further comprising:
determining a reporting configuration associated with the determined value range; and
wherein the information is transmitted using the reporting configuration.

4. The method of claim 1, wherein:
the set of second DL RS correspond to near-field beams.

5. The method of claim 1, wherein:
the value based on the measured received power relates to pathloss; and
the at least one first criterion is satisfied in case the pathloss is below a given value.

6. The method of claim 1, further comprising:
measuring received power of at least one received fourth DL RS; and
selecting, after measuring received power of the received first DL RS, the first DL RS, from the first DL RS and the at least one fourth DL RS, based on their corresponding measured received powers.

7. The method of claim 1, wherein:
the measuring of the determined set of second DL RS is performed in response to a reception of a trigger message.

8. A wireless transmit/receive unit, WTRU, comprising at least one processor configured to:
measure received power of a received first downlink, DL, reference signal, RS, received from a network;
upon determination that a value based on the measured received power satisfies at least one first criterion:
determine a value range to which the value belongs;
determine a set of second DL RS associated with the determined value range;
measure the determined set of second DL RS to obtain a corresponding set of first measurement results;
select a DL RS from the set of second DL RS based on the set of first measurement results; and
transmit, to the network, information indicative of at least one of the selected DL RS and the corresponding first measurement result.

9. The WTRU of claim 8, wherein the at least one processor is further configured to:
upon determination that the value based on the measured received power does not satisfy the at least one first criterion:
measure a set of third DL RS signal to obtain a corresponding set of second measurement results;
select a DL RS from the set of third DL RS based on the second measurement result; and
transmit, to the network, information indicative of at least one of the selected DL RS and the corresponding second measurement result.

10. The WTRU of claim 8, wherein the at least one processor is further configured to:
determine a reporting configuration associated with the determined value range; and
wherein the information is transmitted using the reporting configuration.

11. The WTRU of claim 8, wherein:
the set of second DL RS correspond to near-field beams.

12. The WTRU of claim 8, wherein:
the value based on the measured received power relates to pathloss; and
the at least one first criterion is satisfied in case the pathloss is below a given value.

13. The WTRU of claim 8, wherein:
the value based on the measured received power is the measured received power; and
the at least one first criterion is satisfied in case the measured received power is above a given value.

14. The WTRU of claim 8, wherein the at least one processor is further configured to:
measure received power of at least one received fourth DL RS; and
select, after measuring received power of the received first DL RS, the first DL RS, from the first DL RS and the at least one fourth DL RS, based on their corresponding measured received powers.

15. The WTRU of claim 8, wherein:
the first DL RS is disjunct from the set of second DL RS.

16. The WTRU of claim 8, wherein:
the first DL RS is part of the set of second DL RS.

17. The WTRU of claim 8, wherein the at least one processor is further configured to:
transmit information indicative of the value range.

18. The WTRU of claim 8, wherein the at least one processor is further configured to:
the measuring of the determined set of second DL RS in response to a reception of a trigger message.

19. The WTRU of claim 18, wherein the at least one processor is further configured to:
perform the measuring of the determined set of second DL RS after expiry of a given time interval after reception of the trigger message.

20. A wireless transmit/receive unit, WTRU, comprising at least one processor configured to:
measure received powers of a first set of received downlink, DL, reference signals, RS;
select a first DL RS from the first set based on the measured received powers;
determine a second set of DL RS that is associated with the first DL RS;
measure the determined second set of DL RS to obtain respective measurement results;
determine a RS based on the measurement results; and
transmit information indicative at least one of the determined RS and the respective measurement results.
